(19) United States
(12) Patent Application Publication
(10) Pub. No.: US 2020/0049127 A1
(43) Pub. Date: Feb. 13, 2020

(54) Method For Designing A Wind Turbine Or A Water Turbine Blade

(71) Applicants: Universite Paris Diderot Paris 7, Paris (FR); Ecole Superieure De Physique Et De Chimie Industrielles De La Ville De Paris, Paris (FR); Centre National de la Recherche Scientifique (CNRS), Paris (FR); Universite Pierre Et Marie Curie (Paris 6), Paris (FR)

(72) Inventors: Vincent Cognet, Bourg La Reine (FR); Sylvain Courrech Du Pont, Champigny Sur Marne (FR); Benjamin Thiria, Paris (FR)

(73) Assignees: Universite Paris Diderot Paris 7, Paris (FR); Ecole Superieure De Physique Et De Chimie Industrielles De La Ville De Paris, Paris (FR); Centre National de la Recherche Scientifique (CNRS), Paris (FR); Universite Pierre Et Marie Curie (Paris 6), Paris (FR)

(21) Appl. No.: 16/486,009

(22) PCT Filed: Feb. 14, 2018
(86) PCT No.: PCT/EP2018/053727

§ 371 Date: Aug. 14, 2019

(30) Foreign Application Priority Data
Feb. 14, 2017 (FR) 1751204

(51) Int. Cl. F03D 1/06; F01D 5/14

(52) U.S. Cl. CPC F03D 1/0675; F05D 2230/00; F05D 2240/30; F01D 5/147

(57) ABSTRACT

The invention relates to a method for designing a flexible blade or an articulated rigid blade with one or more torsion springs, for a wind turbine or a water turbine, the flexible blade being designed to passively control the pitch angle of the wind turbine or of the water turbine during operation, the method comprising the following steps: a) receiving the known geometric profile; b) determining a change in the optimal pitch angle, 0o opt rigid, as a function of the specific speed λ; c) determining the local behaviour of the flexible blade or of the articulated blade and local ratios relating to the aerodynamic loading and to the centrifugal force being exerted on the blade; d) determining local values of the bending modulus B of the flexible blade/the stiffness of the torsion spring and of the mass density p of the blade; and e) providing information relating to the selection of the material.

### FIELD OF THE INVENTION

The invention relates to the design of flexible blades and to the determination of their characteristics in order to improve the wind turbine or water turbine performances.

### TECHNOLOGICAL BACKGROUND

Wind energy is booming. However, while the thermal or photovoltaic solar panels are entering private homes, wind energy production remains mainly reserved for large production sites. This phenomenon is partly explained by the lack of versatility of the wind turbines with rigid blades.

A wind turbine is indeed designed to operate at a given incident fluid speed and a given rotational speed. The efficiency of a wind turbine is therefore maximum for a given specific speed, called optimum specific speed λₘₐₓ.

The specific speed λ is defined as the ratio between the speed considered at the end of the blade and the incident fluid speed. Thus, if the fluid speed deviates from the nominal operating value of the wind turbine, the specific speed λ deviates from the optimum specific speed λₘₐₓ and the efficiency of the wind turbine decreases significantly. This is the reason why preliminary meteorological studies are carried out on the area of implementation of a wind turbine prior to its dimensioning.

In addition, in order to maximize the energy extracted by the wind turbine in the fluid path within which the wind turbine is placed, an optimum attack angle β₀ is calculated at the optimum specific speed λₘₐₓ. The attack angle β of a profiled blade is defined as the angle between the chord of the blade and the direction of the relative fluid circulating around the blade, in the rotating reference frame attached to the blade. Moreover, another blade parameter is defined, called pitch angle θ, which is the angle between the plane of rotation of the blade and the chord of the blade.

To the extent that the relative incident fluid speed increases with the height along the blade, it is possible to twist the blades of wind turbines so that the force exerted by the fluid on the blade is the same at all points of the blade, that is to say the attack angle is the same at all points of the blade. The twist of a blade consists in the adaptation of its geometry to keep a similar attack angle all along the blade. A twisted blade has a geometry such that the pitch angle decreases with the height along the blade following a certain change, called twist rate.

The design of a rigid blade therefore defines an optimum attack angle β₀ for a given optimum specific speed λₘₐₓ, and can further define an optimum twist angle associated with the optimum attack angle β₀.

One of the main reasons for the loss of efficiency for specific speed values A different from the optimum specific speed λₘₐₓ is that the attack angle β that maximizes the energy extracted in the fluid path varies according to the specific speed λ. However it is impossible to change the twist of a rigid blade according to the operating regime of a wind turbine. Thus, in order to achieve a high efficiency over the entire operating range of the wind turbine (i.e. at all the incident fluid regimes), the pitch angle of the rigid blade θ is changed as a function of the rotational speed Ω of the wind turbine.

Indeed, when the rotational speed Ω of a wind turbine changes, the attack angle β of the fluid on the rotating blades changes. Thus, the geometry of the blades seen by the fluid is a function of the rotational speed Ω, and cannot be optimal over the entire operating range. If the wind turbine is stopped, the attack angle β and the pitch angle θ are complementary. The aerodynamic torque is then maximum for rather large attack angles β. For a given fluid speed, when the wind turbine accelerates, the apparent attack angle β decreases and when the attack angle β approaches zero, the aerodynamic torque does the same. This limit occurs for rotational speeds Ω all the more lower that the pitch angle θ is large. It is thus understood that the efficiency can be improved by adapting the pitch angle θ to the operating speed.

Currently this variation of the pitch angle θ is done using a motor, placed at the base of each blade, whose movements are determined from the recording of the operating parameters (fluid speed and rotational speed of the blade among others). A solution also known is to place shutters, also controlled by means of motors, on the trailing edges of each blade.

Nevertheless, for small wind turbines, it is too expensive to continuously supply sensors and motors. These small wind turbines therefore do not benefit from the change of the pitch angle and, their efficiency, as well as their operating range are diminished.

There is therefore a need for a method for designing wind turbine blades, in particular of small and medium power, that allow maximizing the efficiency of the wind turbine over a wide range of operation while not being expensive in terms of energy.

### SUMMARY OF THE INVENTION

One of the objects of the invention is to propose a method for designing wind turbine or water turbine blades that operate over a wider range of incident fluid regime, while not being costly in terms of energy and easier to put in place.

Another object of the invention is to propose a method for designing wind turbine or water turbine blades regardless of the size of the wind turbine.

Another object of the invention is to propose a method that can be applied to all the known or future geometries of wind turbine or water turbine blades, in order to improve the efficiency.

Another object of the invention is to propose a method for designing blades whose pitch angle regulation is passive, by making the blade flexible or making it able to rotate about its span.

Another object of the invention is to propose a method for designing blades that is able to start at a lower fluid speed.

Another object of the invention is to propose a method for designing blades that can be easily implemented for mass distribution and, from there, for the industrialization in private homes.

In this respect, in a first part of the invention, the invention proposes a method for designing a predefined wind turbine or water turbine flexible blade, the flexible blade having a known geometrical profile: a known span as well as a thickness and a chord that are known and variable in the spanwise direction, a pitch angle at rest, the flexible blade being designed to be flexible at least according to the chord, for passively regulating the pitch angle of the wind turbine or water turbine in operation, the method comprising the following steps:

a) receiving the known geometrical profile,

b) determining, for said geometrical profile applied to a reference rigid blade, a change of the optimum pitch angle of the reference rigid blade θ_{0 opt rigid} as a function of:
the specific speed λ equal to the ratio between the speed considered at the end of the blade and the incident fluid speed, for a speed regime of the fluid flowing around the reference rigid blade, for a first category of wind turbines/water turbines called horizontal rotation axis wind turbines/water turbines and for which the wind direction U is orthogonal to the plane of rotation of the blade,
the specific speed λ and an angle α, α being the angle of rotation of the blade about the axis for a second category of wind turbines/water turbines called vertical rotation axis or horizontal rotation axis wind turbines/water turbines, when the wind speed U is not orthogonal to the plane of rotation of the blade,

c) determining the local behavior of the flexible blade, deformed under the effect, on the one hand, of the aerodynamic loading of the fluid circulating around flexible blade and, on the other hand, of the centrifugal force exerted on the flexible blade in rotation, and determining local ratios relating to the aerodynamic loading and to the centrifugal force exerted on the flexible blade,

d) determining local values of bending modulus B and mass density ρ, using the local ratios and the behavior of the flexible blade determined in step c), so that the change of an effective pitch angle θ_{0 eff} of the flexible blade, conferred by the flexibility at least according to the chord of the flexible blade, as a function the specific speed λ, corresponds to the change determined in the previous step b), and

e) restituting an information relating to the choice of the material, determined from the local values of bending modulus B and mass density p calculated in step d) and from the geometrical profile received in step a).

Advantageously, a flexible blade according to the span is also considered. As a function of the distance r in the spanwise direction, it is in this case considered that the deformation of the blade is not the same.

The thickness of the blade can be requested by the manufacturer or left free in a certain range of values. In the following, the case where the thickness is left free in a certain range of values is considered.

Advantageously, but optionally, the method for designing a wind turbine or water turbine flexible blade may further comprise at least one of the following characteristics:
in step b), the optimum value λ_{max rigid} is determined, for which the efficiency C_{P} of the wind turbine or water turbine with rigid blades of the same fixed geometrical profile as that of the wind turbine with flexible blades is maximum, and wherein the maximum optimum operating point [θ_{0 opt max rigid}, λ_{max rigid}] is deduced, using the change of the optimum pitch angle of the reference rigid blade θ_{0 opt rigid}, and in step c), a value of the initial pitch angle θ_{0 eff ini} of the flexible blades is determined so that, in operation, the maximum effective operating point [θ_{0 eff max}, λₘₐₓ] of the wind turbine or water turbine having these blades flexible, is equal to the maximum optimum operating point [θ_{0 opt max rigid}, λ_{max rigid}] of the wind turbine or water turbine with rigid blades,
during step c), the local ratios relating to the aerodynamic loading and to the centrifugal force exerted on the flexible blade, are the Cauchy's number C_{y} and the centrifugal number C_{c}, and are determined at each point of the flexible blade, the Cauchy's number C_{y} being the ratio of the moments of the aerodynamic force and elastic force, the product Cc*λ² being the ratio of the moments of the centrifugal force and elastic force,
the Cauchy's number is equal to Cy=ρ_{fluid}U²W_{f}³/(2B), the centrifugal number is equal to C_{c}=ρU₂hW_{f}⁴/(R²B) with, for each considered point of the blade, p being the mass density of the blade, ρ_{fluid} the mass density of the fluid circulating around the blade, U the speed of the incident fluid, W_{f} the length of the flexible part of the chord, B the bending modulus of the blade, R the radius of the blade, h the thickness of the blade, Ω the rotational speed of the blade, λ the specific speed of the blade,
during steps b) to c), the blade is assimilated to a series of beams embedded in a radial rigid rod, and considered at different locations in the spanwise direction, and which deform according to the chord independently of each other, and the change of the effective pitch angle of the flexible blade is determined as a function of the curvilinear abscissa of the chord,
during steps b) to c), the blade is assimilated to a two-dimensional plate embedded in a radial rigid rod, and which deforms according to the chord and to the radius, and wherein the plate equations derived from the Kirchhoff-Love theory are applied,
the information relating to the choice of material relates to the distribution of the material(s) within the flexible blade,
the information relating to the choice of material includes an information on the distribution of the mass density within the flexible blade,
the information relating to the choice of the material includes an information on the distribution of the bending modulus within the flexible blade,
the information relating to the choice of the material includes an information on the insertion of elements external to a blade with fixed geometrical profile,
the wind turbine is assimilated to a two-dimensional plate, and for which the following equation is satisfied:

$${∇}^{2} ( B ( x , y ) {∇}^{2} w ( x , y , t ) = - q ( x , y , t ) - h ( x , y ) ρ ( x , y ) \frac{{\partial }^{2} w ( x , y , t )}{\partial {t}^{2}}$$

where B is the bending modulus, q the loading due to the aerodynamic and centrifugal forces, h the thickness of the plate, ρ the density of the blade and w the transverse deformation of the blade, x and y mark the space, t the time, the left member representing the deformation of the plate, and the first term of the right member represents the loading, and the second term of the right member represents the term of inertia,
During step e), the local values of bending modulus B and mass density ρ are determined so that, in operation, the pitch angle does not vary beyond 6°, with respect to a value of the pitch angle of the blade obtained for a position of the blade at rest.

Alternatively, a method for designing a predefined wind turbine or water turbine flexible blade may be envisaged, the flexible blade having a known geometrical profile: a known span as well as a thickness and a chord that are known and variable in the spanwise direction, a pitch angle at rest, the flexible blade being designed to be flexible according to the chord and to the span, for passively regulating the pitch angle of the wind turbine or water turbine in operation, the method comprising the following steps:

a) receiving the known geometrical profile,

b) determining, for said geometrical profile applied to a reference rigid blade, a change of the optimum local pitch angle of the reference rigid blade θ_{0 opt rigid} (x, y), as a function of the specific speed λ equal to the ratio between the speed considered at the end of the blade and the rigid incident fluid speed and the fluid speed, for a speed regime of the fluid flowing around the reference rigid blade,

c) determining the local behavior of the flexible blade according to the chord, deforming under the effect, on the one hand, of the aerodynamic loading of the fluid circulating around flexible blade and, on the other hand, of the centrifugal force exerted on the flexible blade in rotation, and determining local ratios relating to the aerodynamic loading and to the centrifugal force exerted on the flexible blade,

d) determining local values of bending modulus B(x, y) and mass density ρ(x, y), using the local ratios and the behavior of the flexible blade determined in step c), so that the change of a local pitch angle θ(x, y) of the flexible blade, conferred by the flexibility according to the chord of the flexible blade, as a function of the specific speed λ, corresponds to the change determined in the previous step b), and

e) restituting an information relating to the choice of the material, determined from the local values of bending modulus B(x, y) and mass density ρ(x, y) calculated in step d) and from the geometrical profile received in step a).

In this case, in step b), the optimum value λ_{max rigid} is determined, for which the efficiency C_{P} of the wind turbine or water turbine with rigid blades of the same fixed geometrical profile as that of the wind turbine with flexible blades is maximum, and wherein the maximum optimum operating point [θ_{0 opt max rigid} (x, y), λ_{max rigid}] is deduced using the change of the optimum local pitch angle of the reference rigid blade θ_{0 opt rigid} (x, y), and wherein in step c), a value of the initial local pitch angle θ_{0 eff ini} (x, y) of the flexible blades is determined so that, in operation, the maximum effective operating point [θ_{0 eff max} (x, y), λₘₐₓ] of the wind turbine or water turbine having these blades flexible, is equal to the maximum optimum operating point [θ_{0 opt max rigid} (x, y), λ_{max rigid}] of the wind turbine or water turbine with rigid blades.

It is of course possible to apply the technical characteristics defined above to this alternative embodiment for which the change of a local pitch angle θ(x, y) of the flexible blade is considered.

It is thus possible to consider looking for a Young's modulus, a thickness, and a mass density that depend on the spot on the blade, therefore on x and y.

The thickness of the blade can be requested by the manufacturer or left free in a certain range of values. In the following, we consider the case where the thickness is left free in a certain range of values.

It is also possible to consider a reference rigid blade twisted with θ_{0 opt rigid} (x, y).

The invention also relates to a method for manufacturing a flexible blade of a wind turbine or a water turbine, the method comprising steps of:
implementing the method for designing a flexible blade of a wind turbine or a water turbine previously described so as to design a wind turbine or water turbine flexible blade;
manufacturing said flexible blade according to the design of the wind turbine or water turbine flexible blade obtained.

The invention further relates to a wind turbine or water turbine blade, characterized in that it is flexible according to the chord, and is manufactured according to the manufacturing method described above, the flexibility of said blade passively regulating the pitch angle of the wind turbine or the water turbine in operation.

Advantageously, but optionally, a wind turbine or water turbine blade thus manufactured may further comprise one at least of the following characteristics:
the mass density is inhomogeneous.
the bending modulus is inhomogeneous.
it further comprises inserted external elements.

The invention moreover relates to a wind turbine or water turbine comprising a plurality of flexible blades described above.

The method for designing a flexible blade of a wind turbine or a water turbine described above therefore allows defining the characteristics of a flexible material (in particular rigidity, thickness, density) of wind turbine or water turbine blade which, by bending, adjusts the pitch angle of said blade in the desired manner. This adjustment is achieved without energy consumption (unlike the motor and the sensors).

In addition, with regard to the large structures, the fact of using the flexible blades allows not only replacing the motor without consuming energy, but especially lightening the blades. Indeed, wind turbines or water turbines that recover large powers are of such size that preserving the rigidity of the blades is costly and constraining.

In a second part of the invention, a wind turbine with rigid blades connected to the arms of the wind turbine by torsion springs is made.

The same method as the one above is applied, the only difference being that the torsional stiffness K of the torsion springs is calculated but no longer the bending modulus of the flexible blade.

### DESCRIPTION OF THE DRAWINGS

Other characteristics, objects and advantages of the present invention will become more apparent upon reading the following detailed description, and in relation to the appended drawings given by way of non-limiting examples and wherein:

FIG. 1 illustrates the main dimensions of a wind turbine blade;

FIG. 2 illustrates the concepts of attack angle and pitch angle;

FIG. 3 is an example of change of the optimum pitch angle θ₀ opt rigid value as a function of the specific speed λ;

FIGS. 4a to 4c illustrate an experiment for studying a simplified horizontal rotation axis wind turbine in wind tunnel;

FIGS. 5a to 5c illustrate an example of change of the efficiency of a wind turbine as a function of the rigidity of the blades it comprises;

FIG. 6 is an example of change of the average effective pitch angle θ_{0 eff} of a flexible blade, designed using the described design method (the blade is here assimilated to a series of flexible beams), as a function of the specific speed λ for different values of the Cauchy's number and centrifugal number;

FIG. 7 illustrates the results of an example of a step of comparison with the least squares method in the case of design of a homogeneous two-dimensional blade using the described design method;

FIG. 8 illustrates the results of an example of a step of comparison between the reference curve and the change curve of the effective pitch angle θ_{0 eff} of a blade with a homogeneous two-dimensional blade designed using the described design method;

FIG. 9 is a diagram of an example of an inhomogeneous flexible blade;

FIG. 10 illustrates the results of an example of a step of comparison with the least squares method in the case of the design of an inhomogeneous two-dimensional blade using the described design method;

FIG. 11 illustrates the results of an example of a step of comparison between the reference curve and the change curve of the effective pitch angle θ_{0 eff} of a blade with a inhomogeneous two-dimensional blade designed using the described design method;

FIG. 12 is a diagram of the vertical axis wind turbine of the Darrieus type, with the orthonormal reference frame (θᵣ, θ_{Ω}, θ_{z}) linked to the orthonormal blade;

FIG. 13 illustrates diagrams of the effective wind speeds V=U+RΩ seen by the blade during a revolution (a) in the case where RΩ≤U, (b) in the case where RΩ≥U;

FIG. 14 represents the relationship between the different angles: the pitch angle θ₀, the attack angle β, the angle of inclination of the effective wind V with respect to the incident wind U noted γ, and the angle of revolution, α. Hence the relation α=θ₀+β+γ;

FIG. 15 shows the change of the lift C_{L} (solid line) and drag C_{D} (dotted line) coefficients as a function of the angle of incidence β of the wind on the blade for (a) a law of thin blades C_{L1}=C_{D1}=2, (b) a law of thin blades C_{L1}=1.49 and C_{D1}=1.25, and (c) a law inspired by NACA 0012 profiles;

FIG. 16 shows in a row from above: changes in the γ (solid line) and β (dotted line) angles as a function of the angle α for an incident wind speed U=10 m·s⁻¹ and (a) RΩ=2 m·s⁻¹, (b) RΩ=20 m·s⁻¹; long dotted line, θ₀=0°, short dotted line, θ₀=10°; and in a row from below: respective change of the standard of the speed V of effective wind received by the blade;

FIG. 17 shows the change of the projections of the lift force C\tilde{ }_{L}=C_{L} sin(φ) and of the drag force C\tilde{ }_{D}=C_{D} cos(φ) as well as their difference C\tilde{ }_{L}−C\tilde{ }_{D} as a function of the angle α, for an incident wind speed U=10 m·s⁻¹ and (a) RΩ=2 m·s⁻¹, (b) RΩ=20 m·s⁻¹, in dotted line, θ₀=0°, in solid line, θ₀=20°, the chosen law is the law of thin blades C_{L1}=C_{D1}=2, Figures (c) and (d) represent the respective changes of the aerodynamic moment M, as a function of the angle α;

FIG. 18 shows the change of the projections of the lift force C\tilde{ }_{L}=C_{L} sin(φ) and of the drag force C\tilde{ }_{D}=C_{D} cos(φ) as well as their difference C\tilde{ }_{L}−C\tilde{ }_{D} as a function of the angle α, for an incident wind speed U=10 m·s⁻¹ and (a) RΩ=2 m·s⁻¹, (b) RΩ=20 m·s⁻¹; in dotted line, θ₀=0°, in solid line, θ₀=20; the chosen law is the law of thin blades C_{L1}=1.49 and C_{D1}=1.25; Figures (c) and (d) represent the respective changes of the aerodynamic moment M_{z} as a function of the angle α;

FIG. 19 shows the change of the projections of the lift force C\tilde{ }_{L}=C_{L} sin(φ) and of the drag force C\tilde{ }_{D}=C_{D} cos(φ) as well as their difference C\tilde{ }_{L}−C\tilde{ }_{D} as a function of the angle α, for an incident wind speed U=10 m·s⁻¹ and (a) RΩ=2 m·s⁻¹, RΩ=20 m·s⁻¹; in dotted line, θ₀=0°, in solid line, θ₀=20°; the chosen law is the NACA0012 law presented in FIG. 15; Figures (c) and (d) represent the respective changes of the aerodynamic moment M_{z} as a function of the angle alpha;

FIG. 20 shows the changes of the average aerodynamic moment M_{z} of a blade on a revolution as a function of the pitch angle θ₀, for an incident wind speed U=10 m·s⁻¹ and RΩ=2 m·s⁻¹ (dotted line), RΩ=9 m·s⁻¹ (solid line), RΩ=20 m·s⁻¹ (alternating long and short dotted lines) for (a) a law of thin blades C_{L1}=C_{D1}=2, (b) a law of thin blades C_{L1}=1.49 and C_{D1}=1.25, and (c) a NACA 0012 law;

FIG. 21a represents the forces on the blade of thickness h; the blade is embedded at the point K, located at a distance R from the center of rotation; this blade is inclined at a pitch angle θ₀ with respect to the orthoradial plane passing through K and sees an effective wind V, which arrives with an angle of incidence β on the blade; the forces are, on the one hand, the lift FL and drag FD forces which tend in the situation to increase the pitch angle θ₀ and, on the other hand, the centrifugal force FC which always tends to decrease θ₀; in M(s), these are the components (along the dotted line crossing the blade at the level of M(s)) locally orthogonal to the blade of these forces that make θ₀ vary;

FIG. 21b represents the situation diagram of a profile of reference rigid blade (upper solid line) and flexible blade (lower solid line) at a given height; the centrifugal force FC which applies to the point M(s), located at a curvilinear abscissa s of the embedding point K, is radial; this force is decomposed into a portion locally tangent in M(s) which is balanced by the internal forces of the blade assumed to be inextensible, and into a part Fn locally perpendicular to the blade in M, and which tends to reduce the pitch angle θ;

FIG. 22 shows, in the first row, the change of the optimum pitch angle θ^{opt} of an EAV with rigid blades, that is to say the pitch angle that maximizes the aerodynamic moment (represented in the second row) at set rotational speed and therefore optimizes the efficiency; third row: change of the moment derived from the aerodynamic forces that causes the blade (short dotted line) to bend and of the moment derived from the centrifugal force that causes the blade (long dotted line) to bend; the sum of the two is represented in black line; these calculations are made for C_{Y}=C_{C}^{EAV}=1 and for θ₀=0 degrees since it has been seen earlier that it was the optimum initial rigid pitch angle. If

$$\frac{{\partial }^{3} θ}{\partial {s}^{3}}$$

is positive, then this increases the pitch angle, and vice versa; these figures are plotted for the law of the thin blades C_{L1}=C_{D1}=2 and for an incident wind speed U=10 m·s⁻¹ and for λ=0.2 (first column), λ=0.9 (second column), λ=2 (third column);

FIG. 23 shows: in first row: changes of the optimum pitch angle of an EAV with rigid blades, that is to say the pitch angle that maximizes the aerodynamic moment (represented in the second row) at set rotational speed Ω and therefore optimizes the efficiency; Third row: change of the moment derived from the aerodynamic forces that causes the blade (short dotted line) to bend and of the moment derived from the centrifugal force that causes the blade (long dotted line) to bend. The sum of the two is represented in black line; these calculations are made for C_{Y}=C_{C}^{EAV}=1 and for θ₀=0° since it has been seen earlier that it was the optimum initial rigid pitch angle. If

$$\frac{{\partial }^{3} θ}{\partial {s}^{3}}$$

is positive, then this increases the pitch angle, if

$$\frac{{\partial }^{3} θ}{\partial {s}^{3}}$$

is negative, then it decreases the pitch angle, all these figures are plotted for the law of thin blades C_{L1}=1.49 and C_{D1}=1.25 and for an incident wind speed U=10 m·s⁻¹ and for Λ=0.2 (first column), Λ=0.9 (second column), Λ=2 (third column);

FIG. 24 shows in first row: changes of the optimum pitch angle θ₀^{opt} of an EAV with rigid blades, that is to say the pitch angle that maximizes the aerodynamic moment (represented in the second row) at set rotational speed Ω and therefore optimizes the efficiency. Third row: change of the moment derived from the aerodynamic forces that causes the blade (short dotted line) to bend and of the moment derived from the centrifugal force that causes the blade (long dotted line) to bend. The sum of the two is represented in black line; these calculations are made for C_{Y}=C_{C}^{EAV}=1 and for θ₀=0° since it has been seen earlier that it was the optimum initial rigid pitch angle. If

$$\frac{{\partial }^{3} θ}{\partial {s}^{3}}$$

is positive, then this increases the pitch angle, if

$$\frac{{\partial }^{3} θ}{\partial {s}^{3}}$$

is negative, then it decreases the pitch angle;

all these figures are plotted for the law inspired by NACA 0012 and for an incident wind speed U=10 m·s⁻¹ and for Λ=0.2 (first column), Λ=0.9 (second column), Λ=2 (third column) the law inspired by NACA 0012 and for an incident wind speed U=10 m·s⁻¹ and for Λ=0.2 (first column), Λ=0.9 (second column), Λ=2 (third column);

FIG. 25 represents changes (a) of the efficiency C_{P}, (b) of the average efficiency per revolution C_{P} (c) of the aerodynamic moment M, and (d) of the aerodynamic moment per revolution M of the EAV equipped with rigid blades B=10000 N·m C_{Y}=1.20*10⁻⁴ and C_{C}=1.38*10⁻⁴ (dotted line) and the EAV equipped with flexible blades B=10 N·m, namely C_{Y}=0.12 and C_{C}=0.138 (solid line) as a function of the azimuthal angle α (figures (a, c)) and as a function of the number of rotations Nᵣₒₜₐₜᵢₒₙ; the two wind turbines are initially launched at a rotational frequency f=3 Hz for a resisting torque C=1.1745 N·m and an incident wind speed U=4 m·s⁻¹, a moment of inertia J=4.5 kg·m²; the optimum initial pitch angle θ₀ is calculated and so that, when the effective wind V is parallel to the blade (there is therefore only the centrifugal force acting on the deformation of the flexible blade), the average pitch angle is equal to 0; θ₀=0° for the rigid blades and θ₀=2.74° for the flexible blades;

FIG. 26 represents changes (a, b) of the rotational frequency f and (c, d) of the average pitch angle θₘ of the EAV equipped with rigid blades B=10000 N·m C_{Y}=1.20*10⁻⁴ and C_{C}=1.38*10⁻⁴ (dotted line) and the EAV equipped with flexible blades B=10 N·m, namely C_{Y}=0.12 and C_{C}=0.138 (black line) as a function of the azimuthal angle α (figures (a, c)) and as function of the number of rotations Nᵣₒₜₐₜᵢₒₙ; the two wind turbines are initially launched at a rotational frequency f=3 Hz for a resisting torque C=1.1745 N·m and an incident wind speed U=4 m·s⁻¹, a moment of inertia J=4.5 kg·m²; the optimum initial pitch angle θ₀ is calculated and so that, when the effective wind V is parallel to the blade (there is therefore only the centrifugal force acting on the deformation of the flexible blade), the average pitch angle is equal to 0; θ₀=0° for the rigid blades and θ₀=2.74° for the flexible blades;

FIG. 27 represents a vertical rotation axis wind turbine with torsion springs between the arms and the rigid blades;

FIG. 28 illustrates a flowchart of a first implementation of the design method according to the invention; and,

FIG. 29 illustrates a flowchart of a second implementation of the design method according to the invention.

### DETAILED DESCRIPTION

Although in all what follows, the example of wind turbine blades will be described, the teachings of the invention cannot be limited to this single application. Those skilled in the art understand indeed that the design method described can also be applied to the wind turbine blades or aeronautical propeller blades (drone and/or helicopter rotors) with the same advantages.

The present wind turbine is called predefined wind turbine in the sense that it is characterized in advance by its design (the shape of the rotor, the number, the shape, the orientation and the size of the blades), but also by its generator (which determines the resisting torque as a function of the rotational frequency of the wind turbine).

General Characteristics of a Blade, in Particular a Reference Rigid Blade

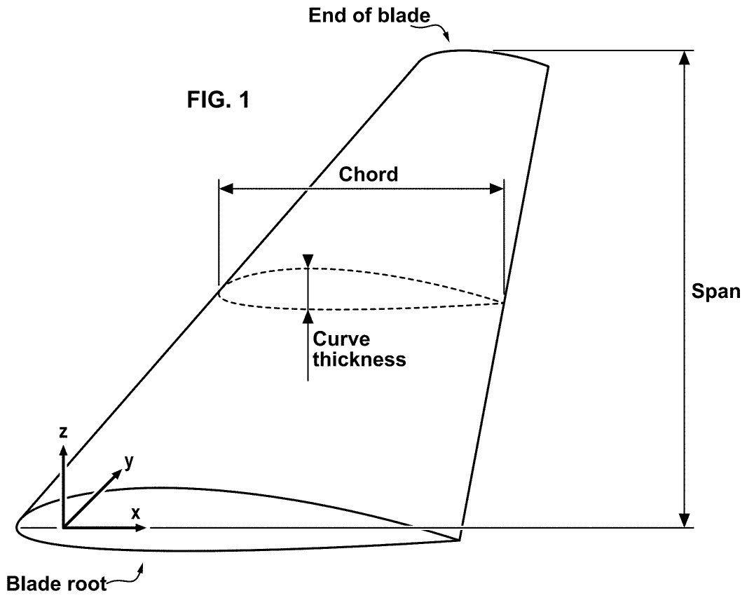

As illustrated in FIG. 1, the geometry of a profiled blade is determined by a camber (along the z direction), a span (along the y direction) and a chord (along the x direction). The camber defines a wind turbine blade thickness that can be variable in the spanwise direction and in the chord direction. The chord length can also be variable in the spanwise direction.

R represents the radius of the blade end, i.e. the distance between the end of the blade and the rotor, depending on the span.

r represents a value of the radius between 0 and R.

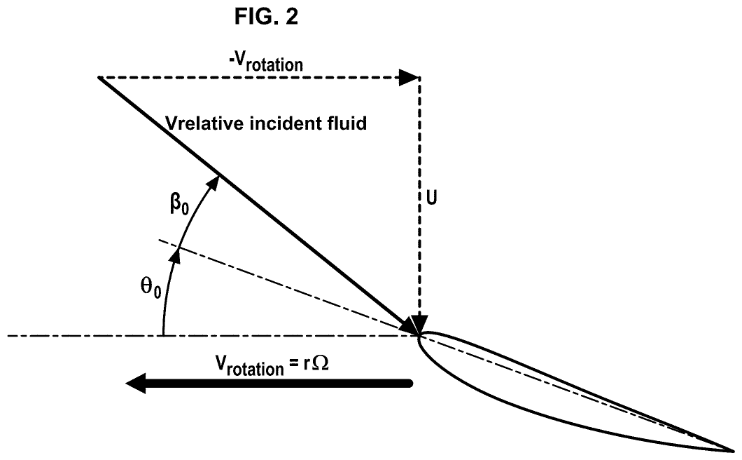

In addition, as described above, and as illustrated in FIG. 2, it is possible to define, in any section of the wing along the span, two parameters of a blade situated in a fluid flow at the speed U: the attack angle β and the pitch angle θ.

In what follows, the attack angle β₀ and the pitch angle θ₀ respectively the attack and pitch angles considered at the end of blade, are chosen. The knowledge of these angles considered at the end of blade sufficient to know all of the geometry of the blade if the twist rate is known.

θ_{0 Rigid} represents the rigid pitch angle for a non-twisted reference rigid blade (i.e. uniform over the entire blade, the same at the end and at the bottom of the blade).

In the case where the reference rigid blade is twisted, θ_{0 rigid} represents the rigid pitch angle at the end of the blade. And in this case, it is θ_{0 opt rigid} (x, y).

The expression ‘reference rigid blade’ used throughout the patent application refers to a rigid blade that cannot rotate around its span, which is set to the arm without the possibility of movement relative to the arm, and that has a given optimum pitch angle.

For a flexible blade or a hinged blade which will be allowed to rotate around its span, θ represents the local pitch angle at a given point of the blade of coordinates (x, y).

θ_{0 eff} represents the average on the blade of the local pitch angle θ (integrated along x and y).

The following proposes a procedure to adjust the pitch angle θ_{0 eff} of the flexible blade or of the hinged blade with the optimum pitch angle θ_{0 opt rig} (for which the efficiency C_{P} is optimized).

By extension, it is possible to search the local characteristics of the flexible blade (Young's modulus, mass density, thickness) or those of the rigid blade hinged to an arm of the wind turbine by one or several torsion spring(s) (mass density, rigid blade and torsion spring), at each point of the blade to adjust the local pitch angle θ, with the local optimal rigid pitch angle (for example in the case of a twisted blade), as previously described.

As explained above, a wind turbine parameter λ, specific speed considered at the end of the blade, is defined as the ratio between the speed considered at the end of the blade and the speed of the incident fluid. Thus, it is

$$λ = \frac{R Ω}{U} ,$$

where x is the radius of the rotor center at the end of the blade, Ω its rotational speed, and U the speed of the incident fluid.

One of the main reasons for the loss of efficiency for specific speed values λ smaller or larger than the optimum specific speed λₘₐₓ stems from the fact that the attack angle β in the rotating reference frame attached to the blades that maximizes the extracted energy in the fluid path depends on the speed of the fluid U and on the rotational speed Ω of the wind turbine and therefore on λ.

Thus, for each value of λ, there is an optimum value of the attack angle β₀ of the wind on the blade at the end of the blade, for a given profile and a given geometry of the blade, and hence, there is an optimum value of the pitch angle θ₀ considered at the end of the blade that maximizes, for this given profile and this given geometry of the blade, the efficiency of the wind turbine.

The initial pitch angle θ_{0 ini rigid} of a reference rigid blade is generally chosen as the optimum value of the pitch angle, at the optimum specific speed λₘₐₓ of the wind turbine. In this regard, a method for designing a known reference rigid blade comprises a prior step of determining an optimum specific speed λₘₐₓ of the wind turbine as a function of the meteorological data of the location of said wind turbine. Such a method further comprises a step of determining an optimum initial pitch angle θ_{0 ini rigid} angle that maximizes the efficiency of the wind turbine at the specific optimum speed λₘₐₓ previously determined. If the wind turbine is equipped with sensor and motor systems as previously described, such a method finally comprises the determination of a change in the optimum pitch angle θ_{0 opt rigid} that maximizes the efficiency of the wind turbine for specific speed values λ different from the specific optimum speed λₘₐₓ previously determined.

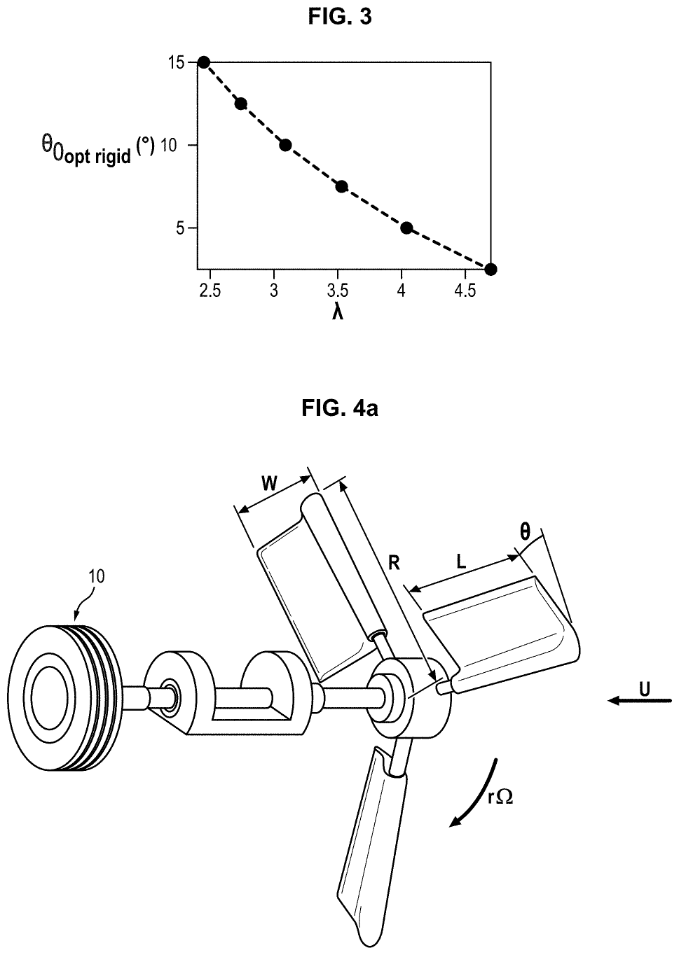

The curve providing the change of the optimum pitch angle θ_{0 opt rigid} that maximizes the efficiency of the wind turbine for specific speed values λ different from the optimum specific speed λₘₐₓ can be determined experimentally or by digital simulation. Generically, the change of the optimum pitch angle θ_{0 opt rigid} is a decreasing function of the specific speed λ. FIG. 3 provides an example of change of the value of the optimum pitch angle θ_{0 opt rigid} as a function of the specific speed λ.

It is understood from the analysis of this change that, in order to achieve a high efficiency over the entire operating range of the wind turbine, the pitch angle θ₀ must vary according to the rotational speed of the wind turbine Ω. In the methods for designing rigid wind turbine blades according to the prior art, this change is not taken into account. The pitch angle θ₀ indeed varies by means of motors and sensors, as described above.

Characteristics of a Flexible Wind Turbine Blade

A method is proposed, allowing to design a flexible wind turbine blade whose effective pitch varies dynamically with the specific speed λ so as to improve the efficiency of the wind turbine over a wide range of specific speed λ, around the optimum specific speed λₘₐₓ.

This method uses the elasticity conferred by the flexible nature of the blade. A flexible blade can indeed deform according to the chord but not according to the span, since the axis of the blade is maintained rigid. It will be understood in the following by “flexible blade”, a blade whose deformation along the chord is large enough to modify the aerodynamics around the wind turbine and therefore the efficiency of the wind turbine (for example by at least 0.5%) compared to a wind turbine with rigid blades.

The blade is flexible due to the ratio of the forces acting on the blade and on the blade rigidity, but also to the boundary conditions (inhomogeneity of the blade for example).

A material constituting a blade is therefore characterized by a bending modulus B and a mass density ρ.

The effective pitch angle θ_{0 eff} of a flexible blade, changes under the combined action of the fluid and the centrifugal force.

Indeed, under the effect of the fluid, the flexible blade bends and thus increases the effective pitch angle θ_{0 eff}. The centrifugal force will, for its part, return the blade into the plane of rotation. The effective pitch angle θ_{0 eff} therefore decreases under the effect of the centrifugal force when the wind turbine rotates sufficiently fast. Thus, a flexible blade is deformed in such a way that the effective pitch angle θ_{0 eff} is a decreasing function of the specific speed λ.

By appropriately choosing the materials constituting the flexible blade, it is possible to adjust the rate of change of the effective pitch angle θ_{0 eff} with the specific speed λ around the operating point, and thus to improve the performances of the wind turbine. Indeed, the smaller the bending modulus B, the more the blade is able to deform. The higher the mass density ρ, the more the centrifugal force (which tends to bring the effective pitch angle θ_{0 eff} to 0°) will become significant.

Comparison of the Behavior Between a Flexible Blade and a Reference Rigid Blade Applicable for a Horizontal Rotation Axis Wind Turbine

The comparative behavior between a flexible blade and a reference rigid blade will now be illustrated. It should be noted that the results presented below are derived from real experiments, carried out in wind tunnel, on reduced-size models.

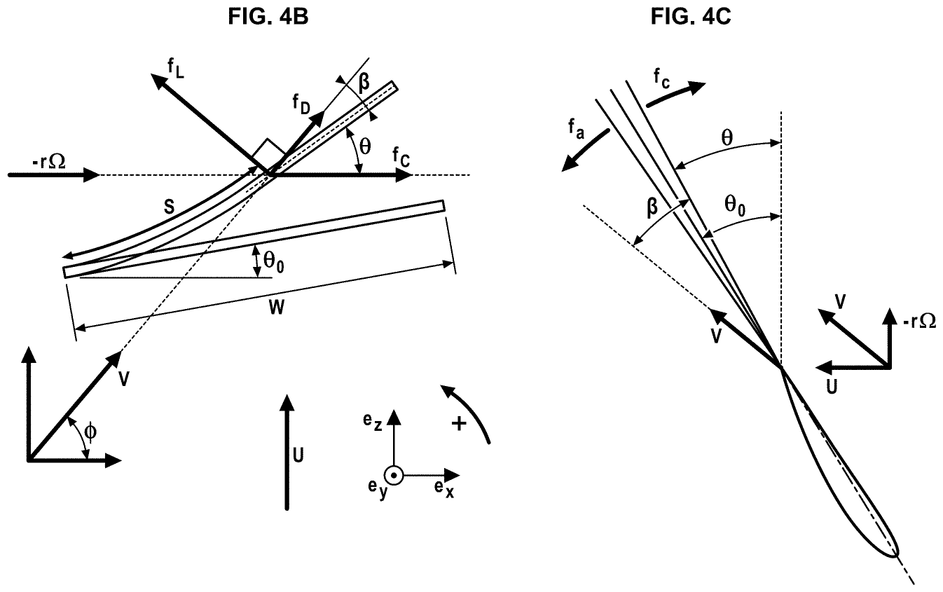

As illustrated in FIG. 4a, the experimental wind turbine has three blades of total span length L=10 cm, total chord length W=4.5 cm. Here W_{f}=4 cm. W=W_{f}+W_{rigid}=4+0.5. The magnetic powder brake 10 serves to simulate the extraction of energy in the fluid path circulating at a speed U around the wind turbine rotating at a rotational speed Ω. The total radius of the wind turbine is R=14.6 cm.

FIG. 4b constitutes a diagram of an orthoradial blade section, in a given radius r of the wind turbine. The blade section has a speed in the stationary reference frame of the rotor being rΩ. In addition, a curvilinear abscissa s is defined along the chord W. The camber has a simple shape which is reduced here to a constant thickness h. Without forcing the fluid (i.e. without rotation or wind speed), the entire blade section has a pitch angle at rest θ₀ equal to 28°. With the forcing of the fluid, the blade deforms with a pitch angle θ in operation, under the combined action of the centrifugal force f_{C} and the aerodynamic force of the fluid (lift f_{L} and drag f_{D} force) which forms an attack angle β with the direction of the relative incident fluid speed V, which is offset by an angle φ with the speed in the stationary reference frame of the rotor.

FIG. 4c illustrates a profile of such a blade in operation for three different values of specific speed λ. The profile of the medium shows the reference situation (without forcing), without rotation or wind speed and the pitch angle at rest GO is equal to 28°. The two profiles on either side of the profile in the reference situation show the blades deformed, respectively for a specific speed value A equal to 0.25 (the value of the pitch angle θ in operation then being equal to 30.8°) and for a specific speed value A equal to 2.35 (the value of the pitch angle θ in operation is then equal to) 25.3°.

It can be seen in these examples that the blade bends in one direction or the other depending on the operating regime, that is to say according to whether the aerodynamic force or the centrifugal force dominates or not.

In this example, for purely illustrative purposes, the flexible blades are Mylar plates fixed to a rigid arm. Thus held, the blades deform mainly according to the chord. The flexibility is modified by changing the thickness of the blades. These sets of blades are compared to rigid blades made of resin.

Firstly, the pitch angle θ₀ of the blades at rest, the fluid speed U, and the resisting torque C that simulates the extraction of energy, are taken as varying over a wide range of operation. The deformation of the blades and the rotational speed Ω of the wind turbine are measured. From there, a power and an efficiency C_{P} are deduced therefrom, such as:

$${C}_{p} = \frac{C Ω}{0 , 5 {ρ}_{air} {U}^{3} π {R}^{2}}$$

where ρₐᵢᵣ is the mass density of the air and R is the radius of the wind turbine. C_{P} is the ratio between the power extracted to the fluid by the wind turbine and the aerodynamic power available on the area swept by the blades.

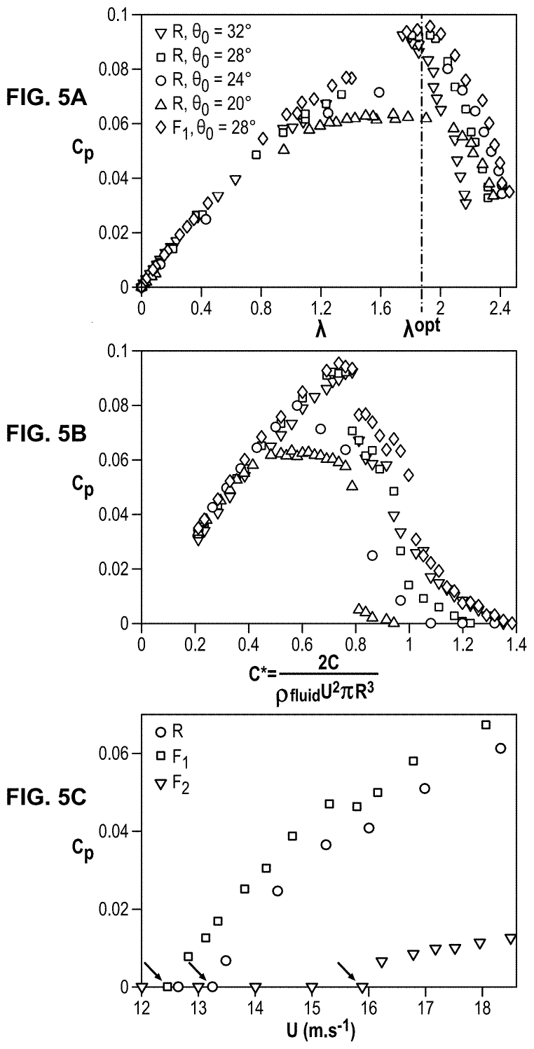

It is already observed that, even for a simplified wind turbine model, flexible blades allow widening the range of operation with respect to rigid blades. FIGS. 5a to 5c indeed illustrate the efficiency C_{P} as a function of the ratio of the specific speed λ and the resisting torque C.

FIGS. 5a to 5c distinguish three curves providing the change of the efficiency C_{P} of the simplified wind turbine studied, having a horizontal axis of rotation, as a function:
for the curve (a), of the specific speed λ,
for the curve (b), of the resisting (adimensioned) torque C*, and
for the curve (c), of the fluid speed U for a fixed resisting torque C=90.9 M(N·m) and a pitch angle θ₀ of 30°.

This change is measured for:
A system F1 where the pitch angle θ₀ is equal to 28° and the blades are in Mylar with a thickness of 250 μm, and
rigid blades (RB) for different pitch angles (θ₀=20°, 24°, 28° and 32°).

For the curves (a) and (b), the measurements are made for a fixed fluid speed U of 13 m·s⁻¹ by varying the resisting torque C.

The curve (c) is plotted for all the systems RB, F1 and F2 (Mylar blades with a thickness of 125 μm). The curve (c) illustrates in particular that a moderate flexibility allows the wind turbine to start earlier.

The represented data correspond to a fixed fluid speed U and a variable resisting torque C. The large values of resisting torque therefore correspond to small values of specific speed λ.

FIGS. 5a to 5c therefore allow comparing the efficiency achieved with a “better” system (250 μm thick Mylar blades and a 28° pitch angle θ₀), with the efficiencies achieved for the rigid blades with pitch angles θ₀ ranging from 20 to 32°. The best efficiency for the rigid blades is achieved for a pitch angle θ₀ of 28°. The flexible blades with a pitch angle θ₀ also of 28° allow achieving the same optimum efficiency at the same operating point λ₀.

FIGS. 5a to 5c also illustrate that, when moving away from the optimum operating point, the flexible blades make it possible to achieve better efficiency. Over the entire operating range, the gain is of 35%. At high rotational speed or large resisting torque, it is necessary to decrease (24°) or increase (32°) the pitch angle of the rigid blades to achieve efficiencies similar to the one achieved with the flexible blades. These values correspond to the angles measured for these operating regimes, on the blades deformed by the fluid and the rotation. The flexibility of the blades can improve efficiency but also allows the wind turbine to start at a lower wind speed than when it is equipped with rigid blades.

Example of Implementation

It is proposed to design a flexible wind turbine blade for which the material properties are determined so as to optimize the adaptation of the effective pitch angle θ_{0eff} with the specific speed λ. The objective is to determine the bending modulus B and the mass density ρ of the flexible blade so as to better adjust the change of the optimum pitch angle θ₀ as a function of the specific speed λ.

By way of example, for purely illustrative purposes, this determination is such that, in operation, the effective pitch angle θ_{0 eff} does not vary beyond 6°, with respect to a value of the pitch angle of the blade obtained for a position of the blade at rest.

By way of non-limiting example, it is possible to design a blade made of inhomogeneous material. This inhomogeneity may concern both the bending modulus B and the mass density of the blade ρ. More particularly, this material may comprise denser inserts anywhere on the chord, but more advantageously at the end of the chord in order to increase the effect of the centrifugal force without making the blade too heavy, and while preserving a fixed geometrical profile.

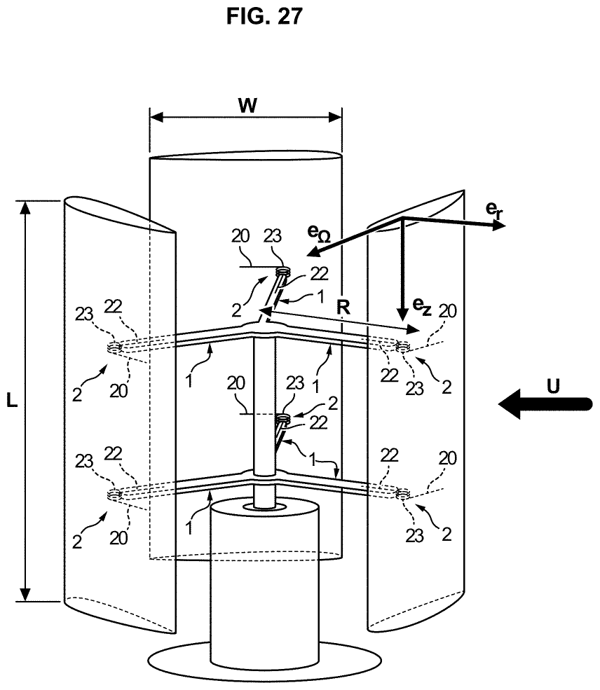

With reference to FIG. 28, the design method comprises for example the following steps:

a) receiving a given geometrical profile of a rigid wind turbine blade, said profile comprising the following elements:
characteristic data of the camber (change of the blade thickness along the span for example),
data characteristic of the span (total length for example),
data characteristic of the chord (change of the chord along the span for example),
an initial blade pitch angle θ_{0 ini rigid}, and

determining, for said geometrical profile applied to a reference rigid blade, a change of the optimum pitch angle of the reference rigid blade θ_{0 opt rigid} as a function of:
the specific speed λ equal to the ratio between the considered speed at the end of the blade and the incident fluid speed, for a speed regime of the fluid flowing around the reference rigid blade, for a first category of wind turbines/water turbines called horizontal rotation axis wind turbines/water turbines and for which the wind direction U is orthogonal to the plane of rotation of the blade,
the specific speed λ and an angle α, a being the angle of rotation of the blade about the axis for a second category of wind turbines/water turbines called vertical rotation axis or horizontal rotation axis wind turbines/water turbines when the wind speed U is not orthogonal to the plane of rotation of the blade,

b) determining the local behavior of the flexible blade deforming under the effect, on the one hand of the aerodynamic loading of the fluid circulating around flexible blade and, on the other hand, of the centrifugal force exerted on the flexible blade in rotation, and determining local ratios relating to the aerodynamic loading and to the centrifugal force exerted on the flexible blade,

c) determining local values of bending modulus B and mass density ρ, using the local ratios and the behavior of the flexible blade determined in step c), so that the change of an effective pitch angle θ_{0 eff} of the flexible blade, conferred by the flexibility at least according to the cord of the flexible blade, as a function of the specific speed λ, corresponds to the change determined in the previous step b), and
d) restituting an information relating to the choice of the material, determined from the local values of bending modulus B and mass density ρ calculated in step d) and from the geometrical profile received in step a).

Advantageously, the flexible blade is considered as flexible depending on the span.

Step a) is known per se. The determination of a geometrical profile of wind turbine rigid blade that maximizes the efficiency of the wind turbine at a predetermined operating point can be carried out by various methods known to those skilled in the art.

Step b) can be carried out by digital simulation, according to methods that are also known, or by experiments, for example on a model of wind turbine rigid blade having the geometrical profile received in step a).

During step b), there is determined the specific speed λ_{max rigid} optimum value for which the efficiency C_{P} of the wind turbine or water turbine with rigid blades of the same geometrical profile received in step a) is maximum. As a result, the maximum optimum operating point [θ_{0 opt max rigid}, λ_{max rigid}] is deduced, using the change of the optimum pitch angle of the reference rigid blade θ_{0 opt rigid}. In any event, steps c) and d) must be carried out for a flexible blade serving under the same conditions as those used to obtain the change determined in step b), in particular in terms of incident fluid speed, rotation of the blades, resisting torque of the rotor, and proportionality between resisting torque and rotational speed of the rotor.

For “real” blade geometrical profiles, the determination of the behavior of a flexible blade, ratios relating to the aerodynamic load and to the centrifugal force exerted on the flexible blade, and flexural moduli B as well as the mass density ρ in all points of the blade that allow the blade to perform a passive adaptation of its pitch angle, cannot be done by analytical resolution. In this case, the dynamic equations must be solved locally in a digital way.

Steps c) and d) can be implemented by any calculation system, unit or module, whether it is a computer program product or any physical device such as a computer processor, a controller or any other logical computer device. The instructions corresponding to these determination steps can in turn be stored on computer storage devices such as a computer hard disk (ROM, RAM), or USB-type removable storage disks.

The data relating to the geometrical profile received during step a), or the information relating to the material restored in step e), just like the calculation instructions, can be transmitted directly to the calculation devices via removable storage devices or directly from the memory of the calculation devices, or via remote transfer devices, such as a Bluetooth Internet connection, or a Wi-Fi link.

By way of non-limiting example, it is possible to assimilate the designed blades to a series of flexible beams, or to a flexible plate. This modeling makes it possible to solve analytically the dynamic equations that govern the passive adaptation of the pitch angle of the flexible blade.

Implementation for a Flexible Blade Assimilated to a Series of Flexible Beams Embedded in a Radial Rigid Rod for a Horizontal Rotation Axis Wind Turbine

As a first approximation, it is possible to assimilate a flexible blade to a series of beams of thickness h embedded in a radial rigid rod (depending on the span), of chord length W_{f}, the beam being taken as a section orthogonal to the span, at a distance r from the center of the rotor.

At low rotational speed, the fluid pushes on the blade and increases the effective pitch angle θ_{0 eff}. This also allows wind turbines equipped with flexible blades to start for a lower wind speed than wind turbines with rigid blades, as will be described below. At high rotational speed, it is the centrifugal force that dominates and tends to bring the blade into the plane of rotation (towards an effective pitch angle θ_{0 eff} of 0°) which delays the critical specific speed λ for which the apparent fluid direction is parallel to the blade and the useful aerodynamic force is zero.

Within the limit of the small deformations, the equation determining the behavior of the rod according to the chord deforming under the effect, on the one hand, of the aerodynamic loading of the fluid circulating around the blade and, on the other hand, of the centrifugal force exerted on the flexible blade in rotation is the following:

$$\frac{{\partial }^{3} θ}{\partial {s}^{3}} = {C}_{y} ( 1 + {λ}^{2} ) [ {C}_{L} ( β ( s ) ) cos ( β ( s ) ) + {C}_{D} ( β ( s ) ) sin ( β ( s ) ) ] - {C}_{C} {λ}^{2} sin ( θ ( s ) ) {\int }_{0}^{s} cos ( {θ}^{′} ( s ) ) {ds}^{′}$$

where θ is the pitch angle of the rod at the distance r from the center of the considered rotor, s the adimensioned curvilinear coordinate in the direction of the chord, A the specific speed of the rod, β the attack angle of the rod, and C_{L} and C_{D} are respectively the drag and lift coefficients. These latter coefficients depend on the flowing regime and on the geometry of the blade.

This equation must satisfy the boundary conditions θ(0)=θ₀ and θ(1)=0. Moreover, this equation highlights two ratios C_{Y} and C_{C} relating to the aerodynamic loading and to the centrifugal force exerted on the flexible blade. These ratios are respectively called Cauchy's number and centrifugal number such as:

$${C}_{y} = \frac{{ρ}_{fluid} {U}^{2} {Wf}^{ 3}}{2 B}$$

$$and$$

$${C}_{C} {λ}^{2} = \frac{{ρΩ}^{2} {hWf}^{ 4}}{B}$$

For a homogeneous blade, the bending modulus B and the mass density ρ are constant, but these coefficients may depend on the distance to the rotor r and on the adimensioned curvilinear abscissa s.

Thus, steps c) and d) here consist in the resolution of the equation above, the free parameters of which are the initial pitch angle θ_{0 eff ini} without rotation or wind speed, the bending modulus B, and the mass density ρ. It is thus possible to determine the material of bending modulus B and density ρ, or the arrangement of materials, that optimize the efficiency. Thus, the flexible blade with a considered dimension has a behavior that best fits the change of the optimum pitch angle θ_{0 opt rigid} of the blade as a function of the specific speed λ around the optimum specific speed λₘₐₓ determined in step b), and that maximizes the efficiency of a wind turbine comprising such a blade when it is placed in a fluid at the specific speed λ.

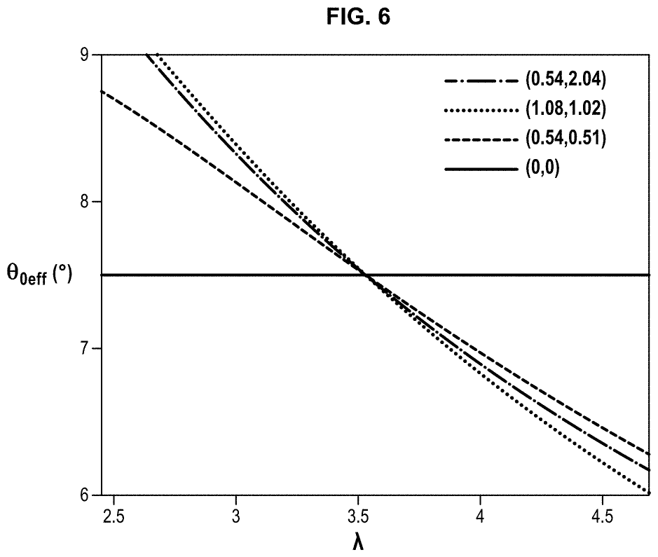

By way of illustration, FIG. 6 represents an example of change of the average effective pitch angle θ_{0 eff} over the entire blade of a horizontal rotation axis wind turbine as a function of the specific speed λ for dynamic coefficients derived from the potential flow theory, where the drag coefficient C_{L} is such that: C_{L}=π sin(β) and C_{D} equal to 0. The black line then represents the rigid case where the pitch angle is constant with the specific speed λ. The long dotted line corresponds to the case where the Cauchy's number C_{Y} is equal to 0.54, and the centrifugal number C_{C} is equal to 0.51. The short dotted line corresponds to the case where the Cauchy's number C₁ is equal to 1.08, and the centrifugal number C_{C} is equal to 1.02. The alternating long and short dotted lines correspond to the case where the Cauchy's number C₁ is equal to 0.54, and the centrifugal number C_{C} is equal to 2.04. For an ideal rod, with a low attack angle β, the drag and lift coefficients and are well described by the laws C_{D}=0 and C_{L}=π sin(β).

FIG. 6 therefore shows different curves of the effective average pitch angle θ_{0 eff} as a function of the specific speed λ. These curves have different variations of the pitch angle as a function of the specific speed λ around the optimum specific speed λₘₐₓ obtained by modifying the values of the Cauchy and centrifugal numbers C_{Y} and C_{C}, that is to say, the flexural moment B, the density ρ. The pitch angle at rest θ_{0 eff ini} (i.e. without rotation or wind speed) has been adjusted so that, in operation, the maximum effective operating point [θ_{0 eff max}, λₘₐₓ] of the wind turbine having these blades flexible, is equal to the maximum optimum operating point [θ_{0 opt max rigid}, λ_{max rigid}] of the corresponding wind turbine with rigid blades.

Implementation for a Flexible Blade Assimilated to a Plate

It is also possible to assimilate the flexible blade to a flexible plate embedded in a radial rigid rod (according to the span), whose equations deformation are provided by the Kirchhoff-Love plate theory, in a conventional manner known to those skilled in the art in continuum mechanics.

The equation determining the behavior of the plate deforming under the effect, on the one hand, of the aerodynamic loading of the fluid circulating around the blade and, on the other hand, of the centrifugal force exerted on the flexible blade in rotation is the following:

$${∇}^{2} ( B ( x , y ) {∇}^{2} w ( x , y , t ) = - q ( x , y , t ) - h ( x , y ) ρ ( x , y ) \frac{{\partial }^{2} w ( x , y , t )}{\partial {t}^{2}}$$

where B is the bending modulus, q the loading of the aerodynamic and centrifugal forces, h the thickness of the plate, ρ the density of the blade and w the transverse deformation of the blade. The equation is written according to two privileged directions of the space, x and y, corresponding to the dimensions of the plate, and t marks the change of the deformation as a function of time. In this equation, the left member represents the deformation of the plate, and the right member represents the term of inertia.

In one embodiment, steps c) and d) can be carried out by systematic testing. Thus, a multitude of sets of parameters (θₛ, C_{y}/u², C_{C}/u²) is tested. The Cauchy and centrifugal numbers C_{y} and C_{C} are added to the incident fluid speed U squared because this speed varies. It is indeed sought to evaluate constant values for each curve giving the change of the pitch angle θ₀ as a function of the specific speed λ. For each set, the average deformation of the blade θ₀ is calculated by means of the plate equation presented above, taking for drag and lift coefficients C_{D} and C_{D} the following: C_{L}=2 sin(β)cos(β) and C_{D}=2 sin(β)²+0.01, with β the attack angle.

Each curve giving the change of the effective average deformation of the blade θ_{0 eff} as a function of the specific speed λ is compared by the least squares method with the change of the optimum pitch angle θ_{0 opt rigid} as a function of the specific speed λ around the specific optimum speed λₘₐₓ determined in step b), and that maximizes the efficiency of a wind turbine comprising such a blade when placed in a fluid at the specific speed λ. Thus, the lower the found value, the more the adjustment is appropriate.

Step d) therefore uses the optimum values (C_{Y}/U²)^{opt} and (C_{C}/U²)^{opt} determined during step c) to determine the material of the flexible blade. Since there are three unknowns (the Young's modulus E, the mass density ρ of the blade, and h its thickness) for two equations, one of the three unknowns must be set. For example, without limitation, it is possible to set the Young's modulus E. The determination of the thickness of the plate h, then of the mass density ρ is performed using the equations below.

$$h = {( \frac{{ρ}_{air} {Wf}^{ 3}}{2 {E ( \frac{{C}_{y}}{{U}^{2}} )}^{opt}} )}^{\frac{1}{3}}$$

$$ρ = \frac{{R}^{2} {h}^{2} {E ( \frac{{C}_{C}}{{U}^{2}} )}^{opt}}{{Wf}^{ 4}}$$

For purely illustrative purposes, there is described below an example of a method for designing a two-dimensional blade illustrating a horizontal rotation axis wind turbine of radius R=20 meters, of total chord length of 1 meter (of which only 90 cm is flexible), rotating at a speed of 33 rpm. These elements correspond to a part of the elements received during step a) of the design method. Step b) is then achieved by digital simulation.

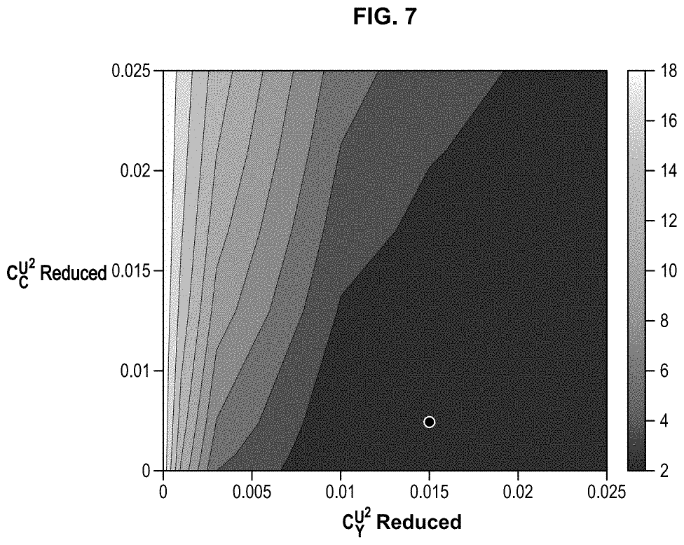

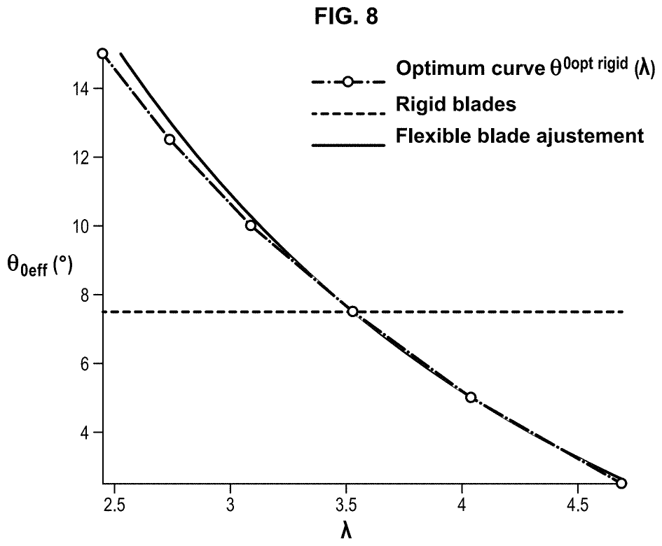

Steps c) and d) as previously described are carried out. The results of comparison with the least squares method are illustrated in FIG. 7. In this case, the determined optimum values are (C_{y}/U²)^{opt}=1.5*10⁻² s²·m⁻² and (C_{C}/U²)^{opt}=3*10⁻³ s²·m⁻² (marked point in the figure). FIG. 8 then illustrates the comparison between the reference deformation obtained during step b) and the deformation of a flexible blade presenting the optimum ratios determined in step c).

For step d), the Young's modulus E is arbitrarily set, then values of thickness h of the blade and mass density ρ are determined. Results of such a step are collected in the table below.

| Test | E (Pa) | h (mm) | ρ (kg · m⁻³) |
|---|---|---|---|
| 1 | 240 * 10⁹ | 0.53 | 1.23 * 10⁵ |
| 2 | 4 * 10⁹ | 2.1 | 3.23 * 10⁴ |
| 3 | 10⁸ | 7.1 | 9.22 * 10³ |
| 4 | 10⁷ | 15.3 | 4.28 * 10³ |
| 5 | 10⁶ | 33.0 | 1.99 * 10³ |

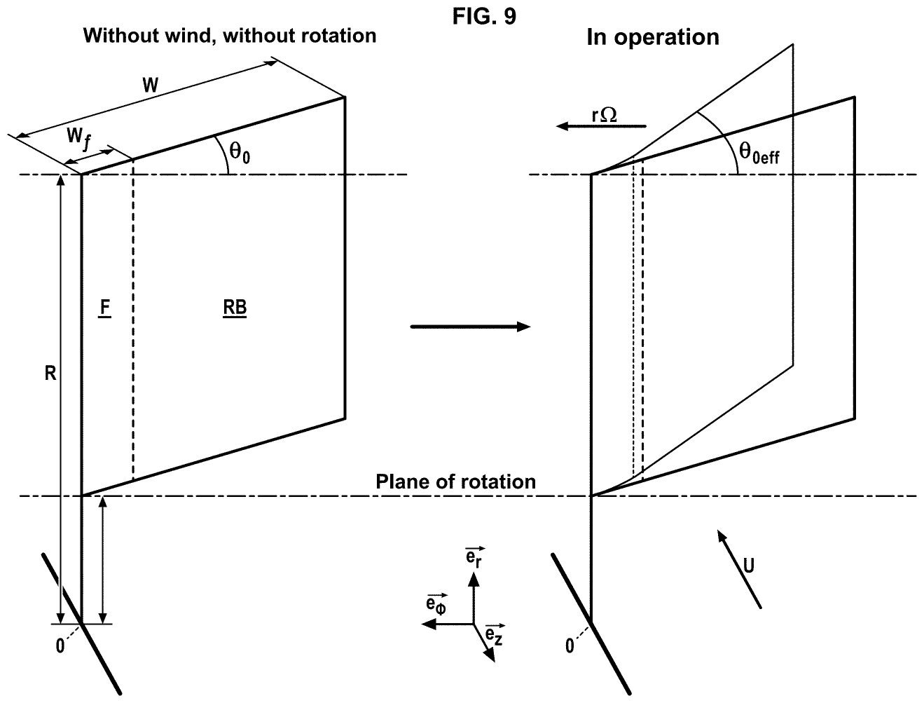

In another embodiment, the plate is inhomogeneous. As illustrated in FIG. 9, the plate is then composed of a flexible part F, close to the rod, of length W_{f}=0.1 meter, and of a rigid part RB over all the rest of the blade, of total length W−W_{f}=0.9 meter. The flexible part therefore serves as a hinge, and its deformation is entirely due to the forces that act on the rigid part. In addition, the wind turbine has a radius R=20 meters, rotating at a speed of 33 rpm.

Steps c) and d) can be carried out by systematic testing. Thus, a multitude of sets of parameters (θ₀, C_{y}/U², C_{C}/U²) is tested. The Cauchy and centrifugal numbers C_{y} and C_{C} are added to the incident fluid speed U squared because this speed varies. It is indeed sought to evaluate constant values for each curve giving the change of the pitch angle θ₀ as a function of the specific speed λ. For each set, the average deformation of the blade θ₀ is calculated by means of the plate equation presented above, taking for drag and lift coefficients C_{D} and C_{D} the following: C_{L}=π sin(β) and C_{D}=0, with β the attack angle.

Each curve giving the change of the effective mean deformation of the blade θ_{0 eff} as a function of the specific speed λ is compared by the least squares method with the change of the effective pitch angle θ_{0 opt rigid} as a function of the specific speed λ around the optimum specific speed λₘₐₓ determined in step b), and that maximizes the efficiency of a wind turbine comprising such a blade when it is placed in a fluid at the specific speed λ. Thus, the lower the found value, the more the adjustment is appropriate.

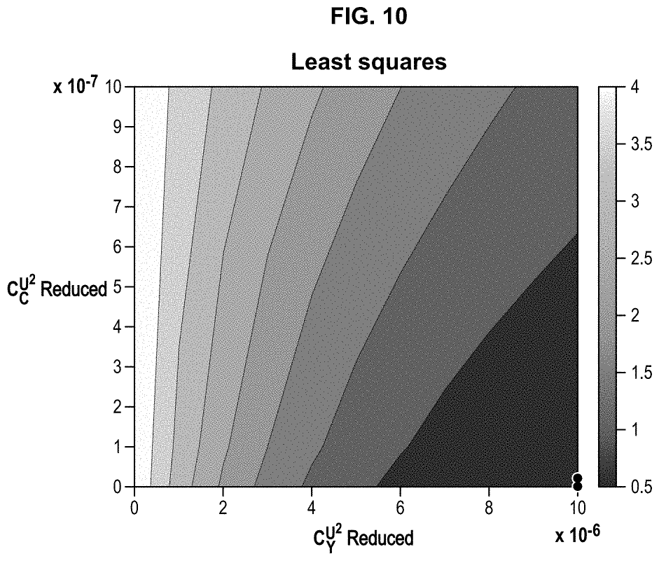

The results of comparison with the least squares method are illustrated in FIG. 10. In this case, the determined optimum values are (C_{y}/U²)^{opt}=1*10⁻⁵ s²·m⁻² and (C_{C}/U²)^{opt} ranging from 10⁻¹¹ to 2*10⁻⁸ s²·m⁻² (points marked in the figure).

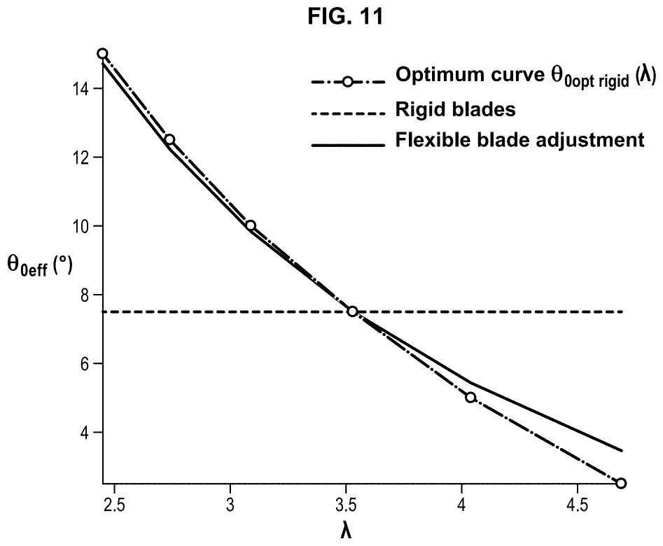

FIG. 11 then illustrates the comparison between the reference deformation obtained during step b) and the deformation of a flexible blade presenting the optimum ratios determined in step c).

Step d) therefore uses the optimum values (C_{y}/U²)^{opt} and (C_{c}/U²)^{opt} determined during step c) to determine the material of the flexible blade.

The difference with the case of the homogeneous blade is that there are two different thicknesses here: on the one hand hᵣ is the thickness of the rigid part and, on the other hand, h_{f} is the thickness of the flexible part of the pale, and the Cauchy and centrifugal numbers divided by the square of the wind speed are written respectively:

$${( \frac{{C}_{Y}}{{U}^{2}} )}^{opt} = \frac{{ρ}_{air} {W}_{f}^{3}}{2 B} = \frac{{ρ}_{air} {W}_{f}^{3}}{2 {E}_{f}^{3}} ; {( \frac{{C}_{C}}{{U}^{2}} )}^{opt} = \frac{ρ {h}_{r} {W}_{f}^{4}}{{R}^{2} B} = \frac{ρ {h}_{r} {W}_{f}^{4}}{{R}^{2} {Eh}_{f}^{3}}$$

By the first equation, the modulus of curvature of the flexible part is determined:

$$B = \frac{{ρ}_{air} {W}_{f}^{3}}{2 {( \frac{{C}_{Y}}{{U}^{2}} )}^{opt}} ,$$

as well as the surface mass of the rigid part:

$$ρ {h}_{r} = \frac{{( \frac{{C}_{C}}{{U}^{2}} )}^{opt} {R}^{2} B}{{W}_{f}^{4}} = \frac{{( \frac{{C}_{C}}{{U}^{2}} )}^{opt} {R}^{2} {ρ}_{air}}{{( \frac{{C}_{Y}}{{U}^{2}} )}^{opt} {W}_{f}}$$

This gives for the flexible part: B=60 kg·m²·s⁻².

| Test | E (Pa) | h_{f} (mm) |
|---|---|---|
| 1 | 240 * 10⁹ | 0.63 |
| 2 | 4 * 0⁹ | 2.5 |
| 3 | 10⁸ | 8.4 |
| 4 | 10⁷ | 18.2 |
| 5 | 10⁶ | 39.1 |

A blade of 630 micrometers of high-strength carbon, or 2.5 millimeters of Mylar or 3.91 centimeters of Young's modulus rubber E=10⁶ Pa may be suitable.

And for the rigid part: ρₕᵣ=0.0024 to 4.8 kg·m⁻².

| Test | ρ (kg · m⁻³) | hᵣ (mm) |
|---|---|---|
| 1 | 10 * 10³ | 2.4 * 10⁻⁴ to 0.48 |
| 2 | 5 * 10³ | 4.8 * 10⁻⁴ to 0.96 |
| 3 | 2 * 10³ | 1.2 * 10⁻³ to 2.4 |
| 4 | 1 * 10³ | 2.4 * 10⁻³ to 4.8 |
| 5 | 0.7 * 10³ | 3.4 * 10⁻³ to 6.9 |

Thus the rigid part of the blade can be composed of high-strength carbon fiber of mass density 2*10³ kg/m³ and thickness 2.4 mm.

Step d) therefore uses the optimum values (C_{y}/U²)^{opt} and (C_{c}/U²)^{opt} determined during step c) to determine the material of the flexible blade. Since there are three unknowns (the Young's modulus E, the mass density of the blade ρ, and h its thickness) for two equations, one of the three unknowns must be set. For example, without limitation, it is possible to set the Young's modulus E. The determination of the thickness of the plate h, then of the mass density ρ, is performed using the equations below:

$$h = {( \frac{{ρ}_{air} {W}^{3}}{2 {E ( \frac{{C}_{y}}{{U}^{2}} )}^{opt}} )}^{\frac{1}{3}}$$

$$ρ = \frac{{R}^{2} {h}^{2} {E ( \frac{{C}_{C}}{{U}^{2}} )}^{opt}}{{W}^{4}}$$

The Young's modulus E is arbitrarily set, then values of thickness h of the blade and mass density ρ are determined. Results of such a step are collected in the table below.

| Test | E (Pa) | h (mm) | ρ (10³ kg · m⁻³) |
|---|---|---|---|
| 1 | 240 * 10⁹ | 0.63 | 3.81 * 10⁻³ to 7.6 |
| 2 | 4 * 10⁹ | 2.5 | 1.1 * 10⁻³ to 2 |
| 3 | 10⁸ | 8.4 | 0.28 * 10⁻³ to 0.56 |
| 4 | 10⁷ | 18.2 | 0.13 * 10⁻³ to 0.26 |
| 5 | 10⁶ | 39.1 | 0.06 * 10⁻³ to 0.12 |

Tests 1 and 2 correspond respectively to a high-strength carbon material and to a Mylar material.

Case of Flexible Blades for a Vertical Rotation Axis Wind Turbine

The vectors are written in bold (ex: V).

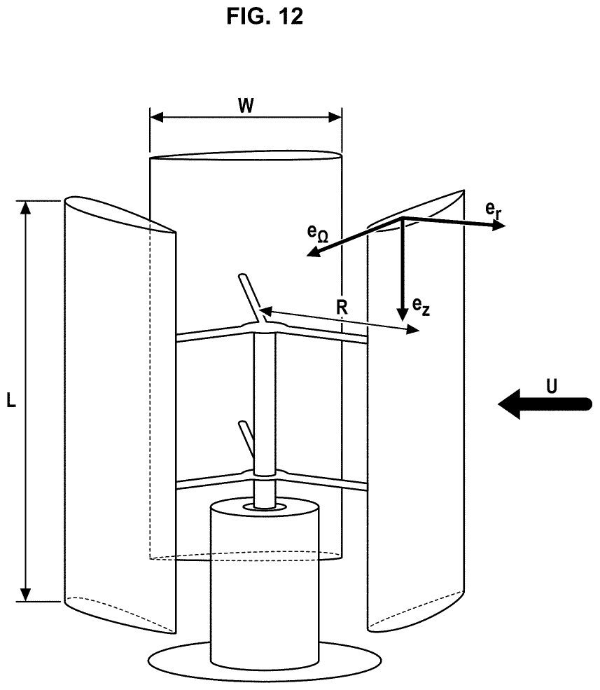

The wind turbine subject of this study is a three-bladed wind turbine with a vertical axis of rotation, of the Darrieus type represented in FIG. 12.

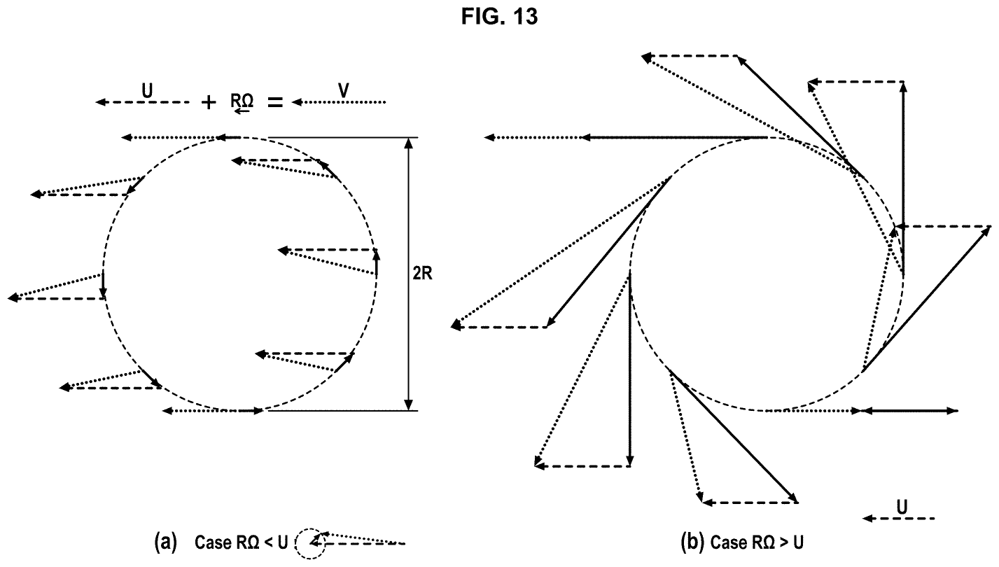

Unlike the horizontal rotation axis wind turbine, this type of wind turbine receives a wind:
that does not depend on the length L;
that varies in standard and in direction during a rotation, which involves the time parameter, even in steady state (i.e. when the incident wind speed U does not vary with time), as shown in FIG. 13.

α is called the azimuth, that is to say the angle that quantifies the rotation of the blade about the axis (for now, only one blade is considered). Conventionally, α=0° is chosen when the component RΩ is collinear and in the same direction as the incident wind speed U (in the diagrams of FIG. 13, this corresponds to the position of the blade at the top of the circle).

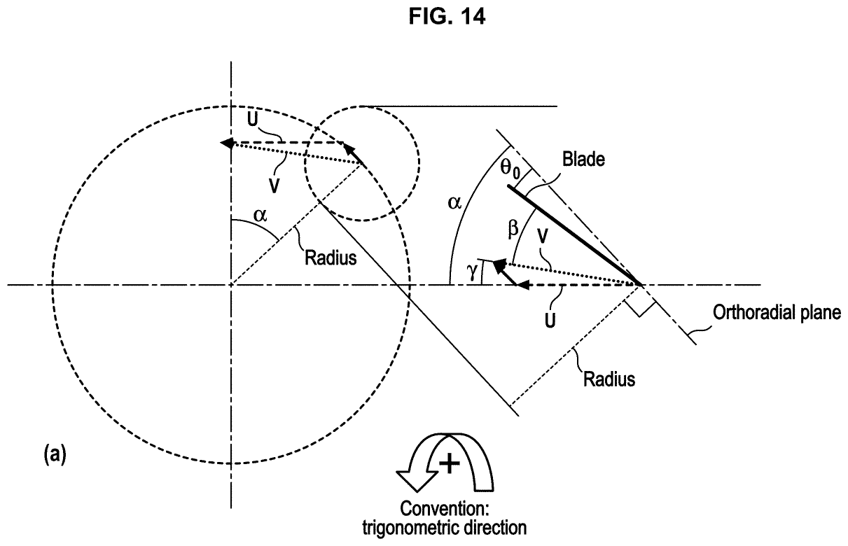

The question of the attack angle β of the effective wind V on the blade arises. FIG. 14 shows that the attack angle is linked to the pitch angle θ₀, to the inclination angle of the effective wind V with respect to the incident wind U noted γ, and to the revolution angle α by the relation:

β=α−θ₀−γ(α,RΩ,U) (1.1.1)

α is known and θ₀ is set. Let's see how γ changes during a rotation. It's about distinguishing two cases.

1) In the case where RΩ≤U (FIG. 13 (a)), then γ∈[−90°; 90° ] and there is the following formula:

$$∀ α , γ = arctan ( \frac{R Ωsinα}{U + R Ωcosα} ) . \qquad ( 1.1 .2 )$$

2) In the case where RΩ≥U (FIG. 13(b)), then γ∈[−180°; 180° ] and the arc tan function must be extended in ±90°:

$$γ = arctan ( \frac{R Ωsinα}{U + R Ωcosα} ) if U + R Ωcos ( α ) \geq 0 \\ γ = π + arctan ( \frac{R Ωsinα}{U + R Ωcosα} ) if U + R Ωcos ( α ) \leq 0 and sin ( α ) \geq 0 \\ γ = - π + arctan ( \frac{R Ωsinα}{U + R Ωcosα} ) if U + R Ωcos ( α ) \leq 0 and sin ( α ) \leq 0 \qquad ( 1.1 .3 )$$

The effective wind speed V=U+RΩ has as a standard:

V=\sqrt{U²+(RΩ)²+2URΩ cos α.} (1.1.4)

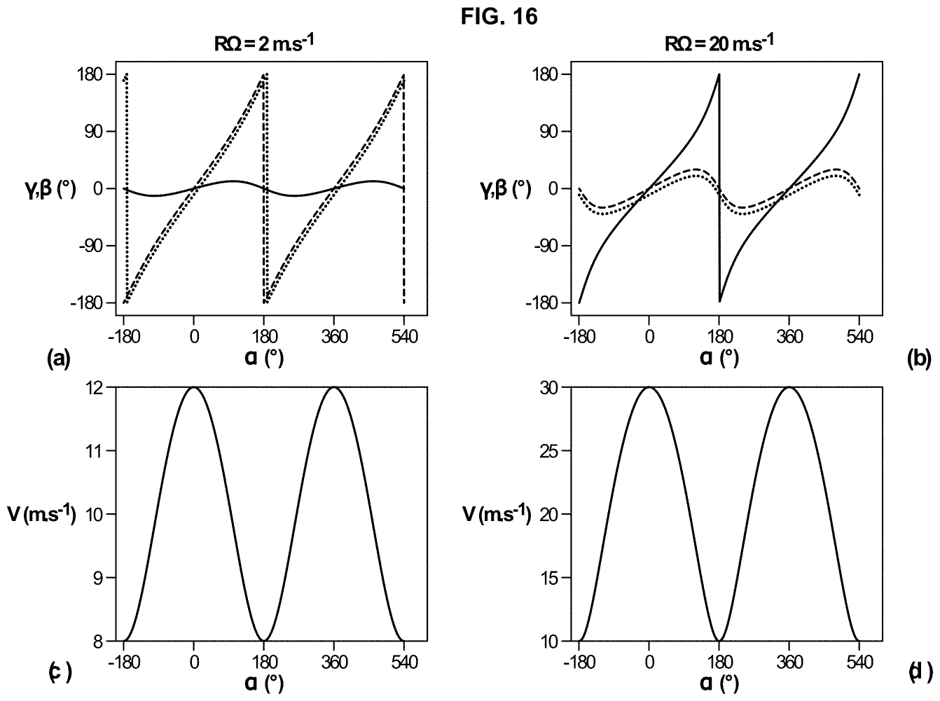

The changes of γ and β as well as those of //V// are represented in FIG. 16 for U=10 m·s⁻¹ and for RΩ=2 m·s⁻¹ and RΩ=20 m·s⁻¹.

These changes are to be completed by the observation of FIG. 13 to see the directions of V:
when RΩ≤U, then, γ∈[−90°; 90° ] and β travels through the entire segment [−180°; 180° ]. Within the limit RΩ<<U, then γ=0 (see equation 1.1.3) and β=α−θ₀.
when RΩ≥U, then, γ∈[−180°; 180° ] and β remains all the more confined around 0° that RΩ is large. Within the limit RΩ>>U, then γ=α (see equation 1.1.3) and β=−θ₀. This limit is very interesting because it suffices to choose the attack angle (through the choice of the pitch angle) for which the aerodynamic moment is maximum in order to optimize the wind turbine.

Aerodynamic Moment M Around the Axis of Rotation

The aerodynamic moment M results from the action of the aerodynamic forces (lift and drag forces) on the blade. First, the infinitesimal moment dM corresponding to the action of these forces on a blade in the base (eᵣ, e_{Ω}, e_{z}) presented in FIG. 12, is calculated.

Hypothesis 1: all the points of the blade receive the same wind, that is to say the wind that reaches the blade fixing point.

Note: because of the extension of the blade along the chord, all the points of the blade do not see the same effective wind (neither in standard nor in direction), but this simplification does not change the mechanism of operation of the blade. This simplification will be rectified in the program in the following.

$$\begin{matrix}dM = ( {Re}_{r} ⋀ ( {dF}_{L} + {dF}_{D} ) ) & ( 1.2 .1 ) \\ ( \begin{matrix}{d}^{2} {M}_{r} \\ {d}^{2} {M}_{Ω} \\ {d}^{2} {M}_{z}\end{matrix} ) = [ ( \begin{matrix}R \\ 0 \\ 0\end{matrix} ) ⋀ \frac{ρ}{2} {V}^{2} dsdz ( \begin{matrix}- {C}_{L} cos ( φ ) - {C}_{D} sin ( φ ) \\ {C}_{L} sin ( φ ) - {C}_{D} cos ( φ ) \\ 0\end{matrix} ) ] , \\ ( \begin{matrix}{d}^{2} {M}_{r} \\ {d}^{2} {M}_{ω} \\ {d}^{2} {M}_{z}\end{matrix} ) = \frac{ρ}{2} {V}^{2} Rdsdr [ ( \begin{matrix}0 \\ 0 \\ {C}_{L} sin ( φ ) - {C}_{D} cos ( φ )\end{matrix} ) ] . & ( 1.2 .2 )\end{matrix}$$

φ represents the angle between the effective wind V and the orthoradial plane: φ=β+θ₀.

Thus only the component dM_{z} along the axis (O_{z}) is non-zero (it is the one that rotates the wind turbine). By integrating dM_{z} over the entire blade, the resultant on aerodynamic moment M_{z} generated by a blade is obtained.

$${M}_{z} = {\int }_{z = 0}^{z = L} {\int }_{s = 0}^{s = W} {dM}_{z} \\ {M}_{z} = {\int }_{z = 0}^{z = L} {\int }_{s = 0}^{s = W} \frac{ρ}{2} {V}^{2} R ( {C}_{L} sin ( φ ) - {C}_{D} cos ( φ ) ) {dsdze}_{z} \\ {M}_{z} = \frac{ρ}{2} {V}^{2} RLW ( {C}_{L} ( β ) sin ( φ ) - {C}_{D} ( β ) cos ( φ ) ) {e}_{z} . \qquad ( 1.2 .3 )$$

The expression of the aerodynamic moment M_{z} shows the drag C_{D} and lift C_{L} coefficients that represent the projections of the pressure force on the blade applying respectively in the direction of the incident wind, and in the plane orthogonal to the direction of the wind. In the following, two aerodynamic laws will be used:

1) The law called “thin blade” law, which applies to low-profiled blades or for high angles of incidence (beyond 30°):

C_{L}=C_{L}_{₁} sin(β)cos(β)

C_{D}=C_{D}_{₂} sin(β)₂. (1.2.4)

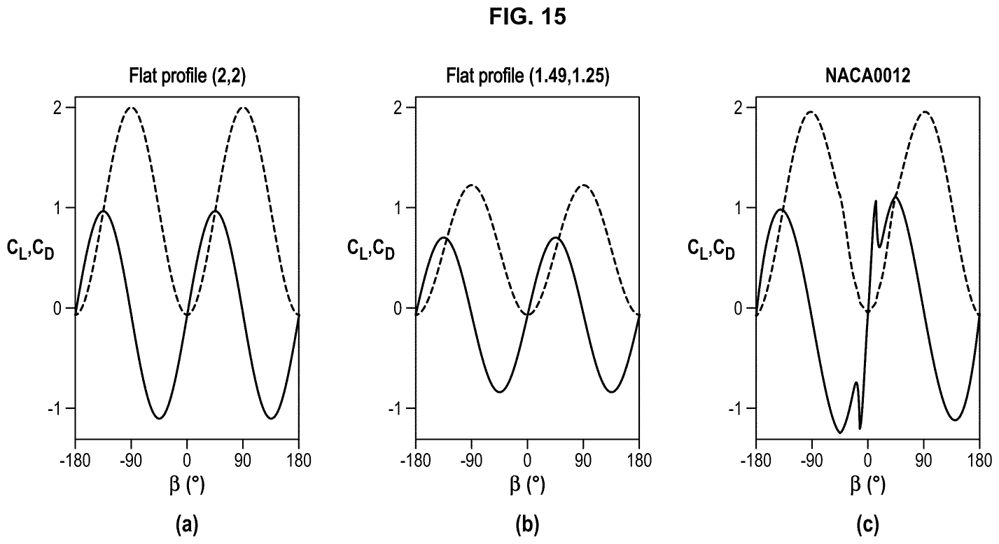

For a blade of infinite aspect ratio AR (infinite length-to-chord ratio), C_{L1}=C_{D1}=2 (see FIG. 15 (a)). C_{L1} and C_{D1} decrease when AR decreases. The following case will also be examined, where C_{L1} and C_{D1} are not equal, inspired by the blades of our experimental wind turbine: C_{L1}=1.49 and C_{D1}=1.25 (see FIG. 15 (b)).

A law inspired by the aerodynamic profile NACA 0012 (see FIG. 15(c)), closer to the aerodynamic force applied to the commercial wind turbine blades.

When RΩ is smaller than U, the angle of incidence β travels through the segment [−180°; 180° ] (see FIG. 16).

When RΩ is greater than U, the angle of incidence β describes a segment included in [−180°; 180° ], centered around 0° and all the more small that RΩ is large (see FIG. 16).

The standard of the effective wind speed V varies between |U−RΩ| and |U+RΩ|, is maximum in α=0° and minimum in α=180° (see FIG. 16 (c, d)).

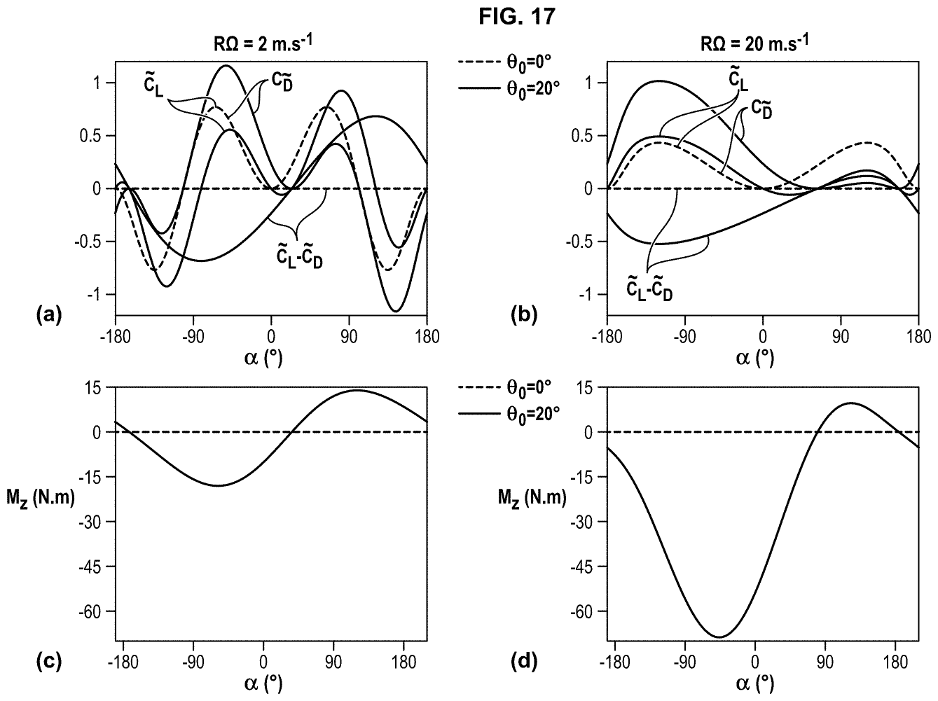

In FIG. 17, as the chosen law is the law of thin blades with C_{L1}=C_{D1}=2, this means that the resulting aerodynamic force is always orthogonal to the blade. If θ₀=0°, then the resultant is radial and the moment M_{z} is identically zero (dotted solid line associated with C\tilde{ }_{L}−C\tilde{ }_{D} in figures (c) and (d)).

When RΩ≤U, then the blade is pushed and braked successively by the drag then the lift force (see the oscillations of the curves associated with C\tilde{ }_{D} et C\tilde{ }_{C}, in Figure (a)): the wind turbine operates successively with the lift then the drag (in the case C_{L1}=C_{D1}=2, the drag is always greater than or equal to the lift, which is not interesting for rotating the wind turbine).

When RΩ≥U, then the blade is pushed by the lift force (positive curves associated with C\tilde{ }_{L}) and braked by the drag force (positive curves associated with C\tilde{ }_{D} in figure (a)): the wind turbine operates at the lift as it is the case for a horizontal-axis wind turbine (in the case C_{L1}=C_{D1}=2, the drag is always greater than or equal to the lift, which is not interesting for rotating the wind turbine).

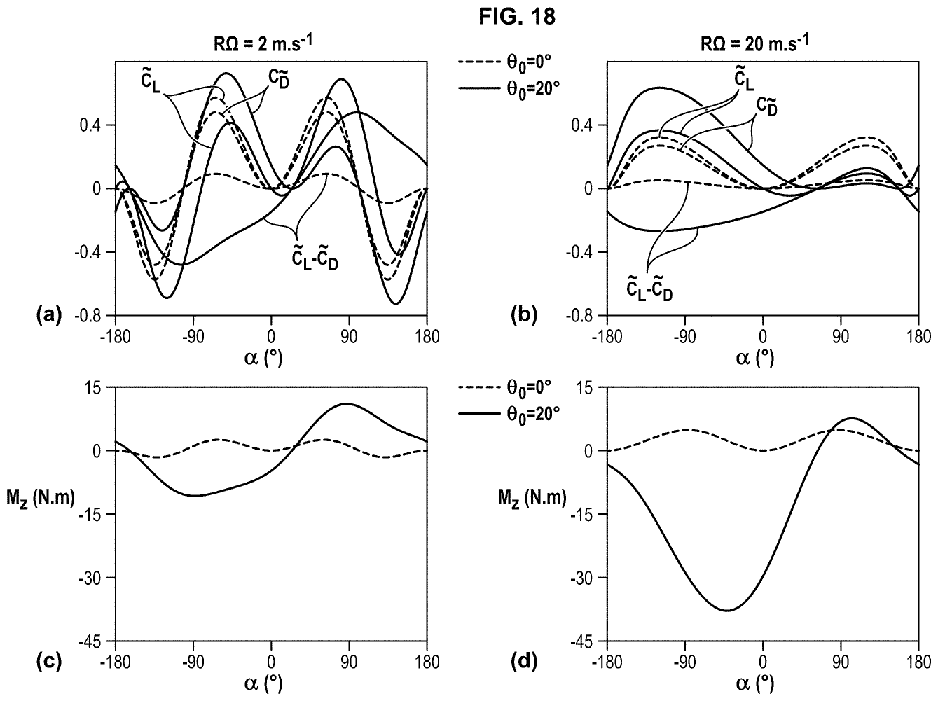

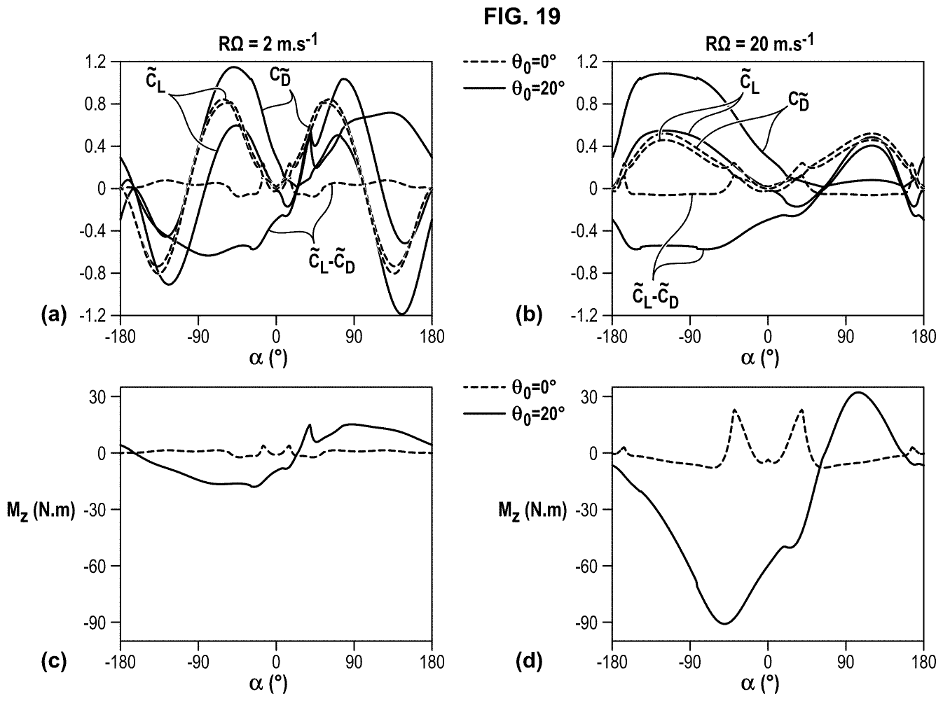

In FIG. 18, C_{L1}=1.49 which is different from C_{D1}=1.25, this means that the resulting aerodynamic force is no longer orthogonal to the blade.

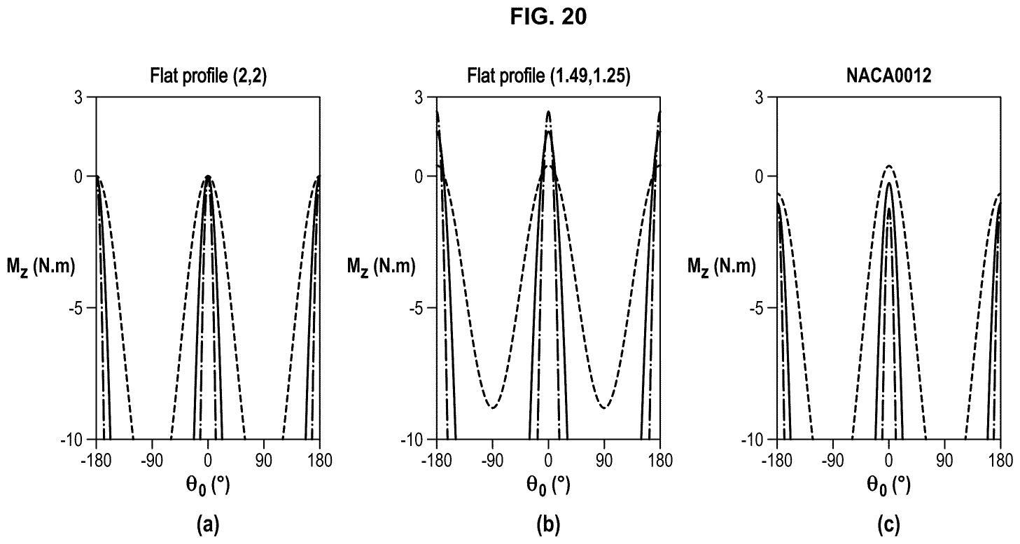

In FIG. 20:
if it is a law of thin blades C_{L1}=C_{D1}=2 (the resultant of the aerodynamic forces is always orthogonal to the blade), the average torque on a revolution is negative or zero.
the average moment on a revolution is maximum in θ° for the three laws studied. This seems consistent with the fact that the vertical-axis wind turbines have zero pitch angles.

Operation of a Vertical-Axis Wind Turbine with Flexible Blades

Equation of Deformation

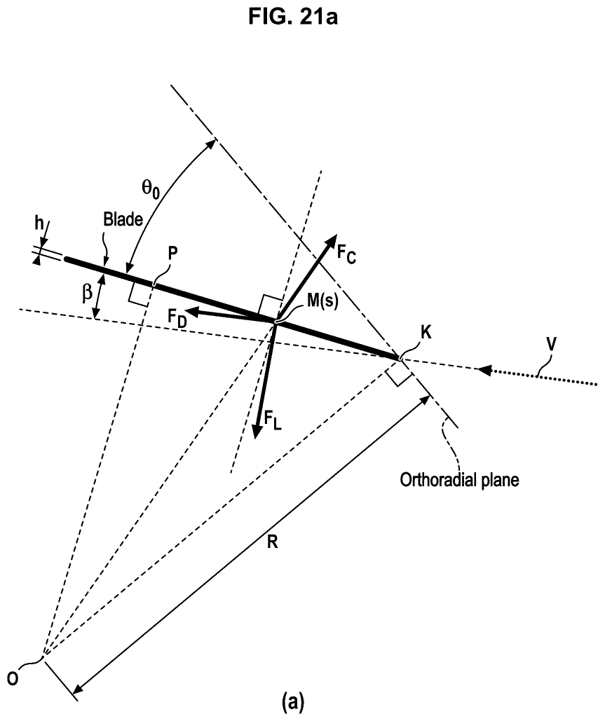

The forces exerted on the blade are the aerodynamic forces—lift force F_{L} and drag force F_{D}—and the centrifugal force F_{C}. These forces are represented in FIG. 21a and FIG. 21b.

It is the components locally orthogonal to the blade that cause the blade to bend (according to the dotted line crossing the blade at the level of M(s) in FIGS. 21a and 21b). It is assumed that the components of these forces locally collinear with the blade are balanced by the inner forces of the blade (non-extensibility of the blade).

The component locally normal to the blade of the pressure forces per unit area at the point M(s) is written:

$${F}_{L}^{n} + {F}_{D}^{n} = {F}_{L} cos ( β ) + {F}_{D} sin ( β ) \\ {F}_{L}^{n} + {F}_{D}^{n} = \frac{ρ}{2} {V}^{2} ( {C}_{L} cos ( β ) + {C}_{D} sin ( β ) ) \\ {F}_{L}^{n} + {F}_{D}^{n} = \frac{ρ}{2} {U}^{2} ( 1 + 2 Λcos ( α ) + {Λ}^{2} ) ( {C}_{L} cos ( β ) + {C}_{D} sin ( β ) ) , \qquad ( 2.1 .1 )$$

where Λ=RΩ/U represents the adimensioned rotational speed by the incident wind speed, as for the EAH.

The component locally normal to the blade of the centrifugal force per unit area at the point M(s) is written:

$${F}_{C}^{n} = - {F}_{C} \frac{PM}{OM} \\ {F}_{C}^{n} = - {ρ}_{m} h {Ω}^{2} OM \frac{OP}{OM} \\ {F}_{C}^{n} = - {ρ}_{m} h {Ω}^{2} OP \qquad ( 2.1 .2 )$$

The sign “−” comes from the fact that the centrifugal force tends to decrease the pitch angle.

In a first approach to take into account the projection of the centrifugal force, small variations of pitch angles θ−θ₀<<θ₀ are considered. Thus, in the triangle OPK rectangle in K, it is shown that:

OP=R²−(R sin(θ₀))²=R|cos(θ₀)|.

The equation of deformation on a beam of width L weakly deformed is:

$$BL \frac{{\partial }^{3} θ}{\partial {s}^{3}} = \frac{ρ}{2} {U}^{2} L ( 1 + 2 Λcos ( α ) + {Λ}^{2} ) ( {C}_{L} cos ( β ) + {C}_{D} sin ( β ) ) - {ρ}_{m} hL {Ω}^{2} R \vert cos ( {θ}_{0} ) \vert . \\ \frac{{\partial }^{3} θ}{\partial {\tilde{s}}^{3}} = \frac{ρ {U}^{2} {W}^{3}}{2 B} ( 1 + 2 Λcos ( α ) + {Λ}^{2} ) ( {C}_{L} cos ( β ) + {C}_{D} sin ( β ) ) - \frac{{ρ}_{m} {hRW}^{ 3}}{B} {Ω}^{2} \vert cos ( {θ}_{0} ) \vert . \\ \frac{{\partial }^{3} θ}{\partial {\tilde{s}}^{3}} = \frac{ρ {U}^{2} {W}^{3}}{2 B} ( 1 + 2 Λcos ( α ) + {Λ}^{2} ) ( {C}_{L} cos ( β ) + {C}_{D} sin ( β ) ) - \frac{{ρ}_{m} {U}^{2} {hW}^{ 3}}{RB} {Λ}^{2} \vert cos ( {θ}_{0} ) \vert . \qquad ( 2.1 .3 )$$

The following operations have been carried out to switch from the first to the second line: division by BL and adimensioning of s=W s\tilde{ }. By adimensioning is meant the partial or total suppression of the units of an equation by an appropriate substitution of variables, in order to simplify the parametric representation of physical problems. To go to the third line, Λ appears in the term of the centrifugal force.

Two adimensioned numbers emerge:

$${C}_{Y}^{EAV} = \frac{ρ {U}^{2} {W}^{3}}{2 B} = {C}_{Y}^{EAH} ; {C}_{C}^{EAV} = \frac{{ρ}_{m} {U}^{2} {hW}^{3}}{RB} = {C}_{C}^{EAH} \frac{R}{W} . \qquad ( 2.1 .4 )$$

Note: if the definitions of the Cauchy and centrifugal numbers given in the patent are desired to be kept, one can very well rewrite the equation in the following form:

$$\frac{{\partial }^{3} θ}{\partial {\tilde{s}}^{3}} = {C}_{Y}^{EAH} ( 1 + 2 Λcos ( α ) + {Λ}^{2} ) ( {C}_{L} cos ( β ) + {C}_{D} sin ( β ) ) - {C}_{C}^{EAH} \frac{R}{W} {Λ}^{2} \vert cos ( {θ}_{0} ) \vert . \qquad ( 2.1 .5 )$$

Full Equation of Deformation

By its deformation, the flexible blade modifies the intensity and direction of the centrifugal force applied to the point M. This effect is taken into account in order to determine the exact equation of the deformation.

According to the definition of the centrifugal force (see FIG. 21b):

δf_{C}(M)=δₘ(M)Ω²OM

δf_{C}(M)=ρₘdshLΩ²OM. (2.2.1)

Yet the component of the centrifugal force that contributes to the bending of the beam is written:

δf_{C}ⁿ(M)=δ_{C}(M)·eₙ(M)

δf_{C}ⁿ(M)=ρₘdshLΩ²OM·eₙ(M)₁ (2.2.2)

Where eₙ(M) is the vector normal to the blade in M. Calculate OM.eₙ(M)

In the orthonormal base (eᵣ, e_{Q}, e_{z}):

$$OM = ( \begin{matrix}R - y ( s ) \\ - x ( s ) \\ 0\end{matrix} ) ; {e}_{n} ( M ) = ( \begin{matrix}cos ( θ ( s ) ) \\ - sin ( θ ( s ) ) \\ 0\end{matrix} ) \qquad ( 2.2 .3 )$$

Thus,

$$δ {f}_{C}^{n} ( M ) = {ρ}_{m} hLds {Ω}^{2} [ ( R - y ( s ) ) cos ( θ ( s ) ) + x ( s ) sin ( θ ( s ) ) ] , \\ δ {f}_{C}^{n} ( M ) = {ρ}_{m} hLds {Ω}^{2} [ cos ( θ ( s ) ) ( R - {\int }_{0}^{s} sin ( {θ}_{0} + arctan ( \frac{\partial z ( {s}^{′} )}{\partial {x}^{′}} ) ) {ds}^{′} ) + sin ( θ ( s ) ) {\int }_{0}^{s} cos ( {θ}_{0} + arctan ( \frac{\partial z ( {s}^{′} )}{\partial {x}^{′}} ) ) {ds}^{′} ] , \qquad ( 2.2 .4 )$$

Where x′ represents the distance between the orthogonal projection of M on the reference rigid blade inclined from θ₀, with respect to the orthoradial plane, and the embedding point.

Discussion

In the case where the blade is rigid,

$$\frac{\partial z ( {s}^{′} )}{\partial {x}^{′}} = 0 et θ = {θ}_{0}$$

hence,

δf_{C}ⁿ(M)=ρₘhLdsΩ²[cos(θ₀)(R−s sin(θ₀)))+sin(θ₀)s cos(θ₀))],

δf_{C}ⁿ(M)=ρₘhLdsΩ² cos(θ₀)R, (2.2.5)

And we get back to the equation 2.1.3. In the weakly flexible case and knowing that θ₀ is close to 0°, there is X(s)=θ(s) and X(s′)=θ(s′).

By developing the equation 2.2.4 to the first order in X, there is:

δf_{C}ⁿ(M)=ρₘhLdsΩ²[(R−∫₀^{s}X(s′)ds′)+X(s)s],

δf_{C}ⁿ(M)=ρₘhLdsΩ²[(R−∫₀^{s}(θ(s)−θ(s′))ds′], (2.2.1)

The term is very small when the blade is weakly flexible and θ₀ is close to 0, since it involves a difference between two terms of order 1. It is not taken into account in the simulations under these conditions.

Simulations of the Direction of Deformation of the Flexible Blade. Comparison with the Optimum Deformation of the Pitch Angle for a Wind Turbine with Rigid Blades

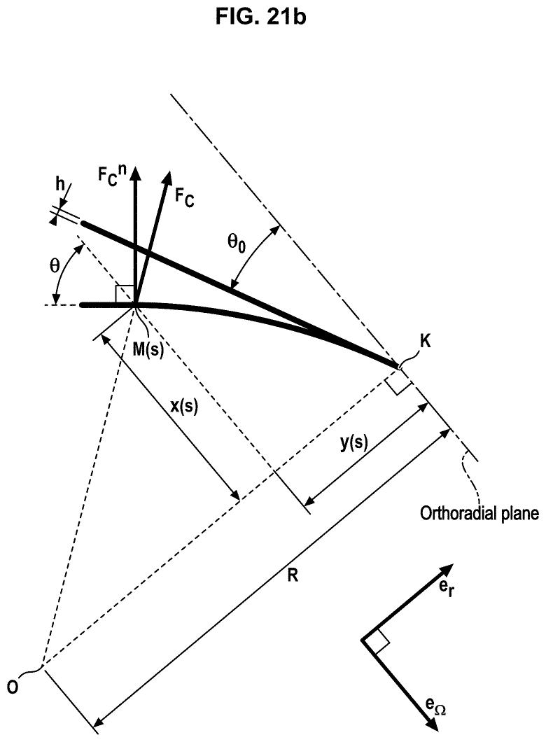

Notes on FIG. 22:
The most important note is that the passive deformation of the blade seems to play a role in improving the performances of the wind turbine. Indeed, the black curves of the third row are positive on [0°; 180° ] like the black curves of the first row: when it is beneficial to increase the pitch angle, the flexible blade also goes in this direction. Conversely, the black curves of the third row are negative on [−180°; 0° ] like the black curves of the first row: when it is beneficial to reduce the pitch angle, the flexible blade also goes in this direction. The centrifugal force decreases the pitch angle over the entire cycle (but this is recoverable by a slight increase of the initial pitch angle, and it is possible to decrease the effect of the centrifugal force with respect to that of the aerodynamic forces by choosing a light and flexible blade).
Regarding the curves of the first row, the program that calculates them is responsible for finding the optimum pitch angle at a given angle α. Note that the program “hesitates” between the value of θₒₚₜ and other values offset by 90°. In the following, only the middle curve is considered (that is to say that starts from θ₀=−90° in α=−180° going in θ₀=90° in α=180° by passing through θ₀=0° in α=0° for the figure at Λ=0.2 for example);
Since the resultant of the aerodynamic forces is for this law orthogonal to the blade, there is normally found that, in the first row, when Λ≤1, θ_{0 opt} (α=0°)=0° since the blade pulls up the wind and θ_{0 opt} (α=±180°)=±90° since the blade has the wind in the back. When Λ≥1, θ₀ (α=0°)=0° and θ_{0 opt} (α=±180°)=±0° since the blade pulls up the wind all the time;
This is consistent with the fact that Mₘₐₓ (α=0°)=0 N·m (second row) since the wind is collinear and of a direction opposite to the movement of the blade;
The centrifugal force does not depend on α, it acts as a constant.

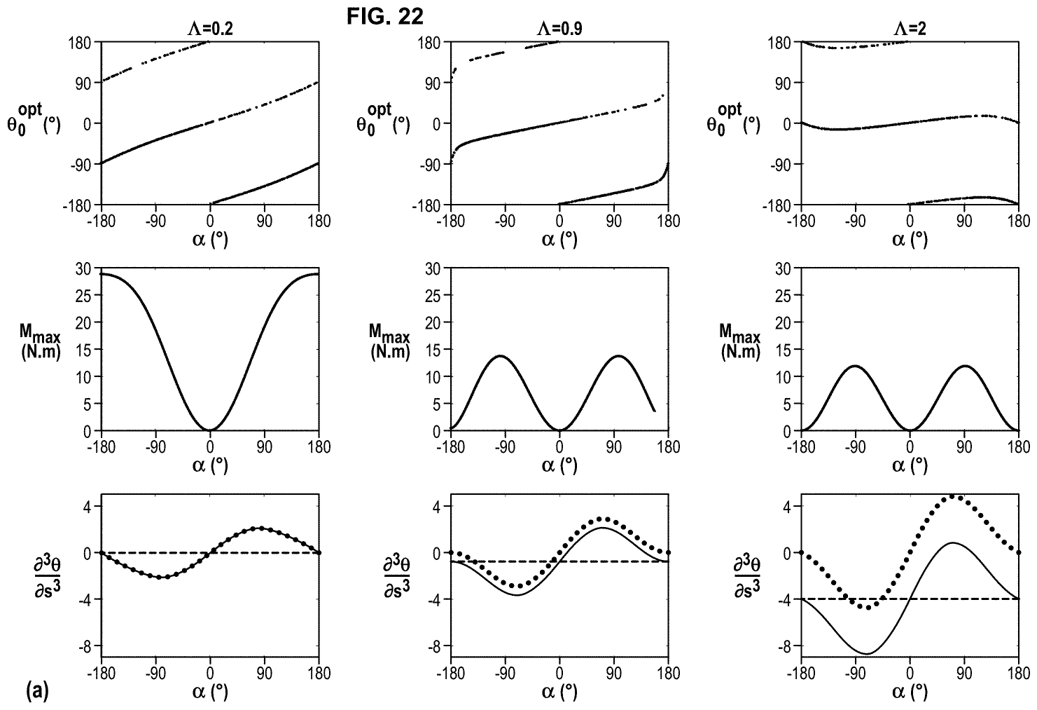

Same notes on FIG. 23 as in FIG. 22.

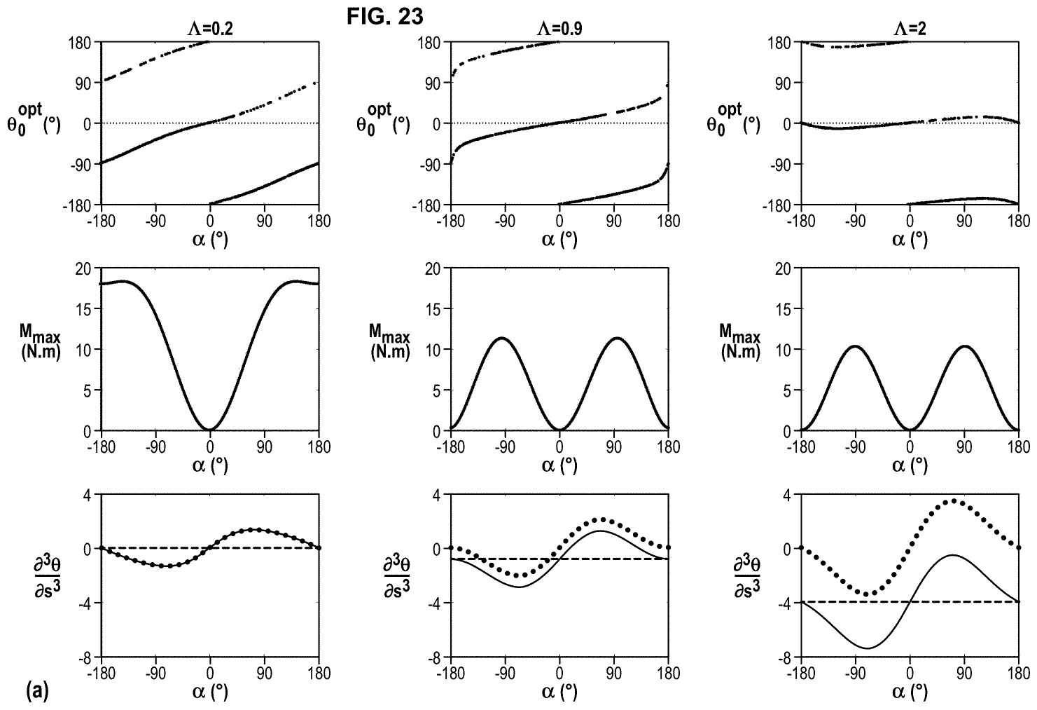

Notes on FIG. 24:

Same as above. The curves θeₒₚₜ (first row) are a little noisy (adjustment of the aerodynamic coefficients to be improved) but the changes are similar to the previous laws: θₒₚₜ ranging from −90° to 90° for Λ≤1, and in all negative cases for α∈[−180°; 0° ] and positive cases for α∈[−0°; 180° ]. This change is well followed by the resultant of the forces that cause the blade to bend: negative for negative a and positive for positive a.

Based on these calculations, it has been possible to see how a vertical-axis wind turbine operates with our model. The latter, despite some second-order approximations, shows that the performances of the EAV can be significantly improved (compare for example the 1 N·m of the average aerodynamic moment of FIG. 9(c) obtained for the set optimum pitch angle to =0.2 and the average 15 N·m of FIG. 13(d) obtained under the same conditions by modifying the pitch angle during the rotation).

The moment equation and the deformation equation for an EAV have been demonstrated and the analogy with the equations for an EAH is strong. The Cauchy and centrifugal numbers are particularly found.

In addition, the third row of FIGS. 22, 23 and 24 shows that the passive deformation of the flexible blade during a revolution under the effect of the aerodynamic and centrifugal forces is in the same direction as the optimization of the pitch angle: reduction of θ₀ if α≤0° and increase of the pitch angle when α≥0°.

These observations regarding the efficiency (the fatigue remains to be explored) show that the use of flexible blades is desirable.

Simulations of the Operation of a Vertical-Axis Wind Turbine with Flexible Blades: Quantification of the Efficiency Gain with Respect to the Same Vertical-Axis Wind Turbine with Rigid Blades

Theory: spatio-temporal deformation equation

During a rotation, the forces on the blade vary in standard and in direction. The deformation of the blade changes during a revolution. Taking into account the term of inertia in the equation of the deformation on a surface section S=L*h located at the curvilinear abscissa s of the embedding point gives:

$${ρ}_{m} S \frac{{\partial }^{2} z}{\partial {t}^{2}} = - EI \frac{{\partial }^{4} z}{\partial {t}^{4}} + \frac{ρ {U}^{2} L}{2} ( 1 + 2 Λcos ( α ) + {Λ}^{2} ) ( {C}_{L} cos ( β ) + {C}_{D} sin ( β ) ) - {ρ}_{m} hL {Ω}^{2} R cos ( {θ}_{0} ) . \qquad ( 2.4 .1 )$$

By using EI=BL and and by adimensioning the lengths x=\tilde{x}W and z=\tilde{z}W, the term is isolated:

$${ρ}_{m} LhW \frac{{\partial }^{2} \tilde{z}}{\partial {t}^{2}} = - BL \frac{W}{{W}^{4}} \frac{{\partial }^{4} \tilde{z}}{\partial {\tilde{x}}^{4}} + \frac{ρ {U}^{2} L}{2} ( 1 + 2 Λcos ( α ) + {Λ}^{2} ) ( {C}_{L} cos ( β ) + {C}_{D} sin ( β ) ) - {ρ}_{m} hL {Ω}^{2} R cos ( {θ}_{0} ) . \\ \frac{{\partial }^{4} \tilde{z}}{\partial {\tilde{x}}^{4}} = - \frac{{ρ}_{m} {hW}^{4}}{B} \frac{{\partial }^{2} \tilde{z}}{\partial {t}^{2}} + \frac{ρ {U}^{2} {W}^{3}}{2 B} ( 1 + 2 Λcos ( α ) + {Λ}^{2} ) ( {C}_{L} cos ( β ) + {C}_{D} sin ( β ) ) - \frac{{ρ}_{m} {hW}^{3} {Ω}^{2} R}{B} cos ( {θ}_{0} ) . \\ \frac{{\partial }^{4} \tilde{z}}{\partial {\tilde{x}}^{4}} = - \frac{{ρ}_{m} {hW}^{4}}{B} \frac{{\partial }^{2} \tilde{z}}{\partial {t}^{2}} + {C}_{Y} ( 1 + 2 Λcos ( α ) + {Λ}^{2} ) ( {C}_{L} cos ( β ) + {C}_{D} sin ( β ) ) - {C}_{C}^{EAV} {Λ}^{2} cos ( {θ}_{0} ) . \qquad ( 2.4 .2 )$$

The adimensioning relevant for the time is indeed the reconfiguration time.

$${τ}_{p} = {W}^{2} \sqrt{\frac{{ρ}_{m} h}{B}} = \frac{{W}^{2}}{h} \sqrt{\frac{12 ( 1 - {v}^{2} ) {ρ}_{m}}{E}} . \qquad ( 2.4 .3 )$$

By having t=\tilde{t}τₚ, the equation 2.4.2 becomes:

$$\frac{{\partial }^{4} \tilde{z}}{\partial {\tilde{x}}^{4}} = - \frac{{\partial }^{2} \tilde{z}}{\partial {\tilde{t}}^{2}} + {C}_{Y} ( 1 + 2 Λcos ( α ) + {Λ}^{2} ) ( {C}_{L} cos ( β ) + {C}_{D} sin ( β ) ) - {C}_{C}^{EAV} {Λ}^{2} cos ( {θ}_{0} ) . \qquad ( 2.4 .4 )$$

Digital Resolution: Discretization of Time

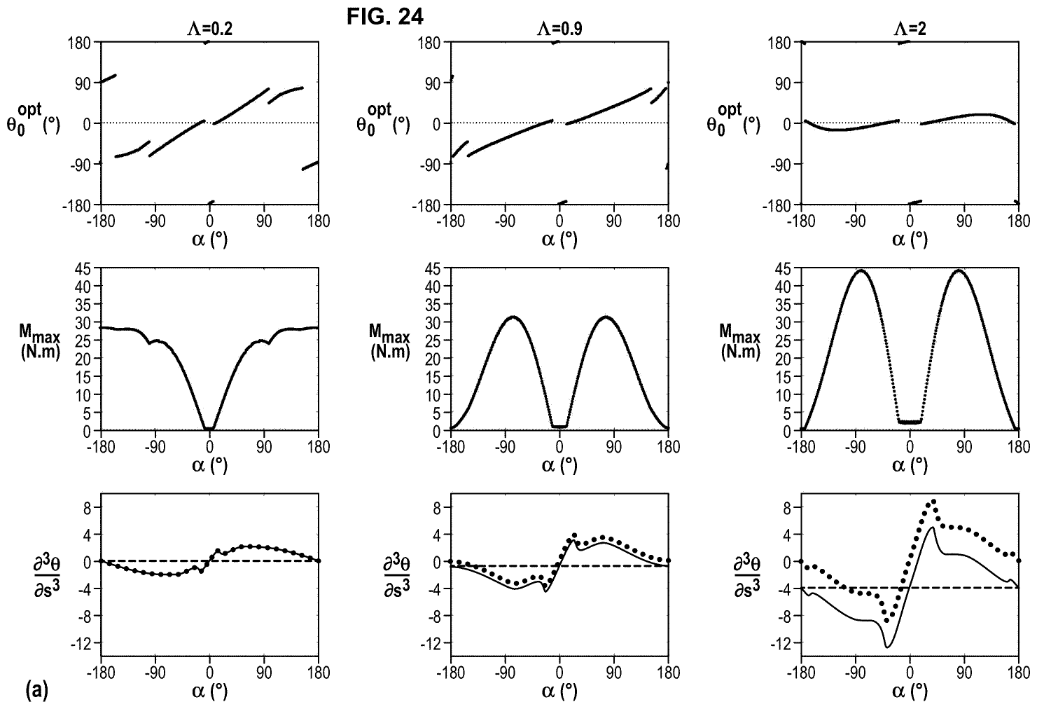

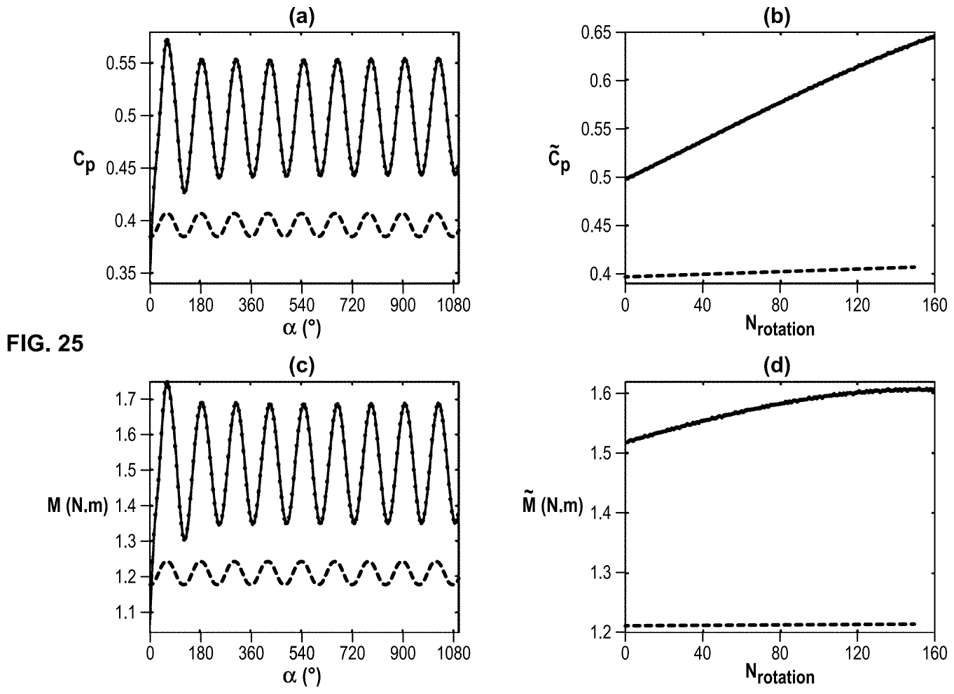

In order to solve the equation 2.4.4, time and space are discretized and the equation is solved in time step Δt. Δt must be as large as possible in order to minimize the calculation time, while remaining smaller than the frequency of the variations of constraints on the blade (see FIGS. 25 and 26).

Second Part of the Invention: Case of Rigid Blades Hinged to an Arm by a Torsion Spring

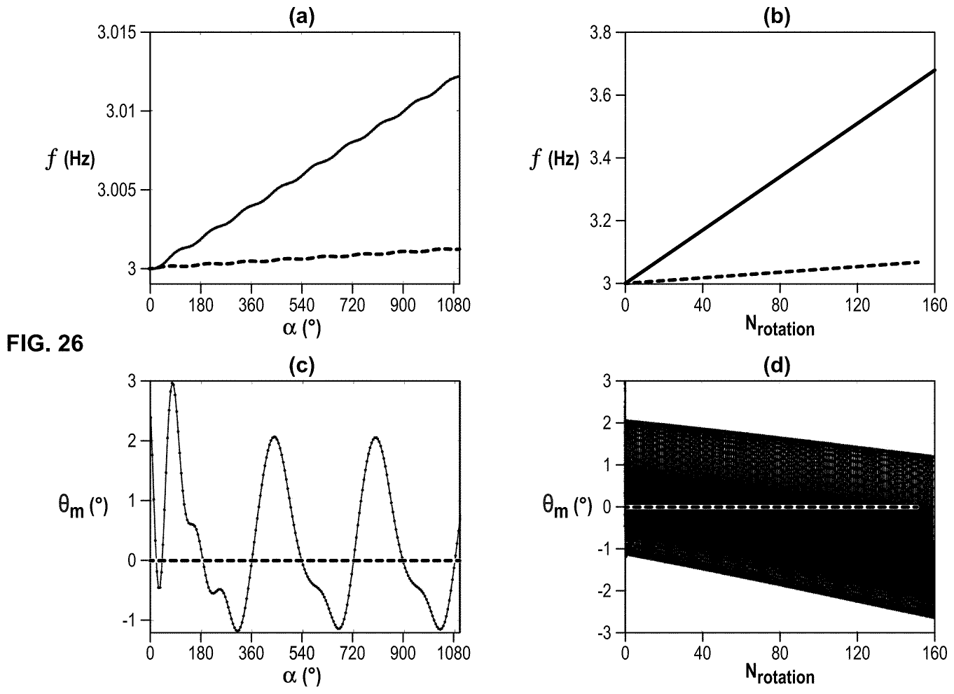

With reference to FIG. 27, the present wind turbine or water turbine comprises:
a plurality of rigid blades each hinged to one or several arm(s) 1 of the wind turbine/water turbine,
at least one torsion spring 2 per arm 1 mechanically connecting the arm 1 and the rigid blade, the stiffness of the torsion spring 2 being chosen to passively regulate the pitch angle of the wind turbine or water turbine in operation,
each blade being hinged to the arm 1 so as to rotate only in the spanwise direction of the blade, under the effect of the torsion spring 2 and of the forces due to the rotation of the blade about the axis of rotation of the wind turbine.

Here, the word ‘hinged’ means that the arm 1 and the blade pivot relative to each other. In the case of the present invention, this hinge is constrained to a single degree of freedom of rotation, about an axis of rotation whose direction is that of the span of the hinged blade.

Thus the elastic response of the torsion spring 2 allows adapting, by an appropriate choice of the stiffness of the torsion spring 2, the pitch angle of the hinged rigid blade so that this pitch angle follows the optimum variation of the pitch angle of a reference rigid blade, and this elastic response is passive, that is to say it does not require at least speed sensors coupled to a motor to adjust the pitch angle, as may be the case for the reference rigid blade.

While for the first category of wind turbines/water turbines, the span of the blade is the direction according to the radius R of the blade, for the second category of wind turbines/water turbines, the span of the blade is the height L of the blade, in particular for the hinged rigid blade.

Advantageously, the mass density of the rigid blades hinged to one or several arm(s) and the stiffness of the torsion springs are determined by the design method of the invention.

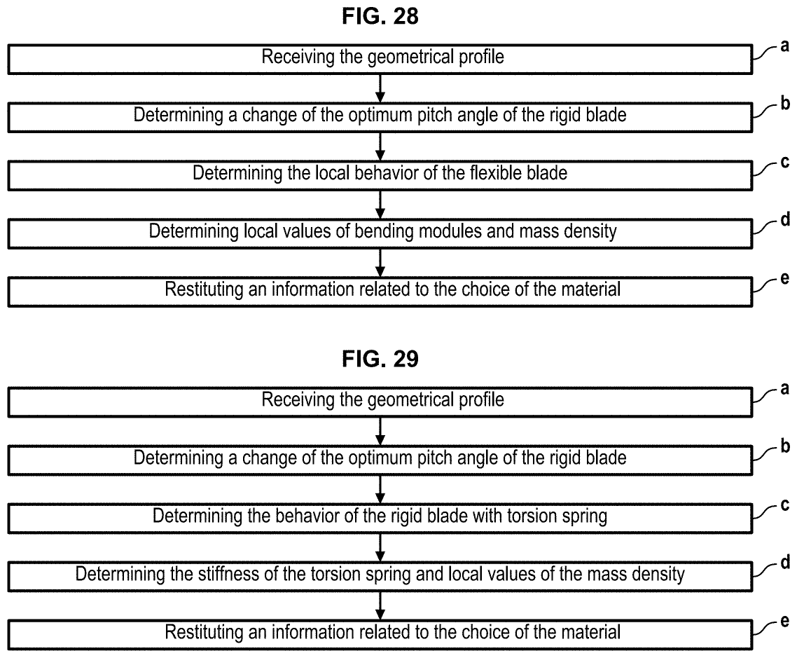

With reference to FIG. 29, the method applied to these hinged rigid blades has the following stages:

a) receiving the known geometrical profile of rigid blades,

b) determining, for said geometrical profile applied to a reference rigid blade, a change of the optimum pitch angle of the rigid blade θ_{0 opt rigid} as a function of the specific speed λ equal to the ratio between the speed considered at the end of the blade and the incident fluid speed, for a fluid speed regime flowing around the rigid blade,

c) determining the behavior of the rigid blade with torsion spring 2 moving under the effect, on the one hand, of the aerodynamic loading of the fluid circulating around this rigid blade and, on the other hand, of the centrifugal force exerted on this rigid blade in rotation, and determining local ratios relating to the aerodynamic loading and to the centrifugal force exerted on this rigid blade,

d) determining the stiffness K of the torsion spring 2 and local values of the mass density ρ of the hinged rigid blade, using the local ratios and the behavior of the rigid blade determined in step c) so that the change of an effective pitch angle θ_{0 eff} of the rigid blade, conferred by the torsion of the spring of the rigid blade, as a function of the specific speed λ, corresponds to the change determined in the previous step b), and

e) restituting an information relating to the choice of the material of the hinged rigid blade, and to the stiffness K of the torsion spring.

The wind turbine/water turbine blade hinged with its spring 2 satisfies the following equation:

$$K ( θ ( t ) - {θ}_{0} ) = - {\int \int }_{blade} l ( x , y , t ) q ( x , y , t ) dxdy - \frac{{d}^{2} J θ}{{dt}^{2}}$$

where K is the spring constant of the torsion spring(s) 2, θ is the pitch angle of the blade, θ₀ is the initial pitch angle of the blade (when no force is applied to the blade at rest), l(x, y, t) is the distance between the point of the blade considered on the integral and the axis of rotation of the torsion spring 2, q(x, y, t) is the loading due to the aerodynamic and centrifugal forces, J is the moment of inertia of the blade with respect to the axis of rotation of the torsion spring(s), J being defined by the following formula:

$$J ( t ) = {\int \int }_{blade} h ( x , y ) ρ ( x , y ) {l}^{2} ( x , y , t ) dxdy$$

where h(x, y) is the thickness of the blade, ρ(x, y) is the mass density of the blade, and l(x, y, t) is the distance between the considered blade point of coordinates (x, y) and the axis of rotation of the torsion spring 2.

The local ratios are the Cauchy's number equal to C_{y}=ρ_{fluid}U²W_{f}²R/(2K) and the centrifugal number equal to C_{c}=ρU²hW_{f}³/(RK) with, for each considered point of the hinged rigid blade, K the stiffness of the torsion spring 2, p mass density of the blade, ρ_{fluid} the mass density of the fluid circulating around the blade, U the speed of the incident fluid, W the length of the chord of the considered blade element, R the radius of the blade, h the thickness of the blade.

Advantageously, as shown in FIG. 27, the wind turbine has a vertical axis of rotation or a horizontal axis of rotation when the wind speed U is not orthogonal to the plane of rotation of the blade.

In this case, for example, one end 20 of the torsion spring 2 is fixed inside the rigid blade, a second end 22 is fixed to the arm 1, the axis of the turn 23 of the torsion spring 2 being collinear with the span (according to the vector e, in FIG. 27).

The turn 23 may be bearing on the arm 1 and/or housed in the blade or bearing on the blade. All configurations can be envisaged to the extent that the hinged rigid blade can rotate only with respect to the arm along a rotation whose direction is the own span of this rigid blade.

In one embodiment, as shown in FIG. 27, each hinged blade is connected to the hinge axis by several arms 1.

In one embodiment, different torsion springs 2 with different stiffnesses K, K′, a stiffness K, K′, different by arm, are hinged to the blade.

The diagram of FIG. 27 is not exclusive.

The attachment points of the blade and the torsion springs 2 may be located in other places, particularly by bringing them closer to the leading edge of the hinged rigid blade.

The number of torsion springs 2 is not fixed to that in the diagram: more or fewer can be put.

The method described in the present application thus allows determining the characteristics of the springs 2 to be used (stiffness K, length, diameter).

For example, in one possible embodiment, the arm 1 has a means for supporting the blade, located in a housing of the blade, this support means allowing the rotation of the hinged blade, the support means being a pivot connection or a ball joint.

Third Part of the Invention: Case of the Flexible Blades Hinged to an Arm by a Torsion Spring.

In a third part of the invention, it may also be provided a vertical rotation axis wind turbine or water turbine comprising:
a plurality of flexible blades each hinged to one or several arm(s) 1 of the wind turbine/water turbine,
at least one torsion spring 2 per arm 1 mechanically connecting the arm 1 and the flexible blade, the stiffness of the torsion spring 2 being chosen to passively regulate the pitch angle of the wind turbine or water turbine in operation,
each flexible blade being hinged to the arm 1 so as to rotate in the spanwise direction of the blade, under the effect of the torsion spring 2 and of the forces due to the rotation of the blade around the axis of rotation of the wind turbine.

In this case, the elastic response of the torsion spring 2 and the blade flexibility allows adapting the pitch angle of the hinged flexible blade, by a suitable choice of the stiffness of the torsion spring 2 and the flexibility of the blade, so that this pitch angle follows the optimum variation of the pitch angle of a reference rigid blade, and this elastic response is passive, that is to say it does not require at least speed sensors coupled with a motor to adjust the pitch angle, as may be the case for the reference rigid blade.

In this case, the design method according to the invention allows:
in step d), after having calculated the forces that apply to the hinged flexible blade, determining local values of bending modulus B, mass density ρ, and of stiffness K of the torsion spring, using the local ratios and the behavior of the flexible blade determined in step c) so that the change of an effective pitch angle θ_{0 eff} of the hinged flexible blade, conferred by the torsion of the spring of the rigid blade and the flexibility of the blade, as a function of the specific speed λ, corresponds to the change determined in the previous step b), and
in step e), restituting an information relating to the choice of the material, determined from the local values of bending modulus B, mass density ρ, and from value of torsional stiffness K, calculated in step d), and from the geometrical profile received in step a).

1. A method for designing a predefined wind turbine or water turbine flexible blade, the flexible blade having a known geometrical profile: a known span as well as a thickness and a chord that are known and variable in the spanwise direction, a pitch angle at rest, the flexible blade being designed to be flexible at least according to the chord, for passively regulating the pitch angle of the wind turbine or water turbine in operation,
the method comprising the following steps:
a) receiving the known geometrical profile,
b) determining, for said geometrical profile applied to a reference rigid blade, a change of the optimum pitch angle of the rigid blade θ_{0 opt rigid} as a function of the specific speed λ equal to the ratio between the speed considered at the end of the blade and the incident fluid speed, for a speed regime of the fluid flowing around the reference rigid blade,
c) determining the local behavior of the flexible blade, deforming under the effect, on the one hand, of the aerodynamic loading of the fluid circulating around flexible blade and, on the other hand, of the centrifugal force exerted on the flexible blade in rotation, and determining local ratios relating to the aerodynamic loading and to the centrifugal force exerted on the flexible blade,
d) determining local values of bending modulus B and mass density ρ, using the local ratios and the behavior of the flexible blade determined in step c) so that the change of a effective pitch angle θ_{0 eff} of the flexible blade, conferred by the flexibility at least according to the chord of the flexible blade, as a function of the specific speed λ, corresponds to the change determined in the previous step b), and
e) restituting an information relating to the choice of the material, determined from the local values of bending modulus B and mass density ρ calculated in step d) and from the geometrical profile received in step a).

2. The method according to claim 1, wherein the flexible blade is a flexible blade of a first category of wind turbines/water turbines called horizontal rotation axis wind turbines/water turbines and for which the wind direction U is orthogonal to the plane of rotation of the blade.

3. The method according to claim 1, wherein the flexible blade is a flexible blade of a second category of wind turbines/water turbines called vertical rotation axis or horizontal rotation axis wind turbines/water turbines, when the wind speed U is not orthogonal to the plane of rotation of the flexible blade, and in this case θ_{0 opt rigid} is also a function of α, α being the azimuthal angle (angle of rotation of the blade about the axis), and in step b), with each specific speed λ is associated a distribution of θ_{0 opt rigid} (α).

4. The method according to any of claims 2 to 3, wherein:
in step b), the optimum value λ_{max rigid} is determined, for which the efficiency C_{P} of the wind turbine or water turbine with reference rigid blades of the same fixed geometrical profile as that of the wind turbine/water turbine with flexible blades is maximum, and wherein the maximum optimum operating point [θ_{0 opt max rigid}, λ_{max rigid}] or respectively the maximum optimum operating point [θ_{0 opt max rigid} (α), λ_{max rigid}], is deduced, using the change of the optimum pitch angle of the reference rigid blade θ_{0 opt rigid} for the first category of wind turbines/water turbines or respectively that of the optimum pitch angle of the reference rigid blade θ_{0 opt rigid} (a) for the second category of wind turbines/water turbines,
and in step c), a value of the initial pitch angle θ_{0 eff} ini of the flexible blades is determined so that, in operation, the maximum effective operating point [θ_{0 eff max}, λₘₐₓ] for the first category of wind turbine/water turbine or respectively [θ_{0 eff max(α)}, λₘₐₓ] for the second category of wind turbine/water turbine having these blades flexible, is equal to the maximum optimum operating point [θ_{0 opt max rigid}, λ_{max rigid}] or respectively [θ_{0 opt max rigid} (α), λ_{max rigid}], of the wind turbine or water turbine with reference rigid blades.

5. The method according to any of claims 2 to 4, wherein during step c), the local ratios relating to the aerodynamic loading and to the centrifugal force exerted on the flexible blade, are the Cauchy's number C_{y} and the centrifugal number C_{c}, and are determined at each point of the flexible blade, the Cauchy's number C_{y} being the ratio of the moments of the aerodynamic force and elastic force, the product C_{c}*λ² for the first category of wind turbine/water turbine, or respectively C_{C}*λ²*(R/W) for the category of second wind turbine/water turbine, being the ratio of the moments of the centrifugal force and the elastic force.

6. The method according to claim 5, wherein the Cauchy's number is equal to C_{y}=ρ_{fluid}U²W_{f}³/(2B), the centrifugal number being equal to C_{c}=ρU²hW_{f}⁴/(R²B), with, for each considered point of the flexible blade, ρ is the mass density of the blade, ρ_{fluid} the mass density of the fluid circulating around the blade, U the speed of the incident fluid, W_{f} the length of the flexible part of the chord, B the bending modulus of the blade, R the maximum radius of the wind turbine, h the thickness of the blade.

7. The method according to any of claims 5 to 6, wherein, when the flexible blade is inhomogeneous and decomposable into sections, a section of the flexible blade consisting of a flexible part F, near the rod, of length W_{f}, and of a rigid part over all the rest of the blade, of total length W−W_{f}, the Cauchy and centrifugal numbers are written:
$${( \frac{{C}_{Y}}{{U}^{2}} )}^{opt} = \frac{{ρ}_{fluid} {W}_{f}^{3}}{2 B} = \frac{{ρ}_{fluid} {W}_{f}^{3}}{2 {Eh}_{f}^{3}} ; {( \frac{{C}_{C}}{{U}^{2}} )}^{opt} = \frac{ρ {h}_{r} {W}_{f}^{4}}{{R}^{2} B} = \frac{ρ {h}_{r} {W}_{f}^{4}}{{R}^{2} {Eh}_{f}^{3}} ,$$
with hᵣ being the thickness of the rigid part, B the modulus of curvature (in N·m) of the considered flexible part with, for each considered point of the blade, ρ the mass density of the blade section, ρ_{fluid} the mass density of the fluid circulating around the blade, U the speed of the incident fluid, W_{f} the length of the flexible part of the chord, R the maximum radius of the wind turbine.

8. The method according to any of claims 1 to 7, wherein during steps b) to c), the flexible blade being assimilated to a series of beams embedded in a radial rigid rod, and considered at different locations in the spanwise direction, and which deform according to the chord independently of each other, and the change of the effective pitch angle of the flexible blade is determined as a function of the curvilinear abscissa of the chord.

9. The method according to any of claims 1 to 5, wherein the flexible blade being designed to be flexible also according to the span.

10. The method according to any of claims 2 to 9, wherein during steps b) to c), the flexible blade is assimilated to a two-dimensional plate, embedded in a radial rigid rod, and which deforms according to the chord and possibly according to the radius, and wherein the plate equations derived from the Kirchhoff-Love theory are applied.

11. The method according to any of claims 1 to 10, wherein in step b, to determine the change of θ_{0 opt rigid} (λ) for the first category of wind turbine/water turbine, or respectively of θ_{0 opt rigid} (λ, α) for the second category of wind turbine/water turbine:
λ is set, there is determined the maximum efficiency C_{P}, or respectively the maximum average efficiency Cₚ on a 360° rotation of α about the axis of rotation, of the wind turbine or water turbine with reference rigid blades, and
θ_{0 opt rigid} is deduced therefrom for the first category of wind turbine/water turbine, or respectively θ_{0 opt rigid} (α) for the second category of wind turbine/water turbine,
and this calculation is repeated for each set λ.

12. The method according to any of claims 2 to 11, wherein in step b, to determine the change of θ_{0 opt rigid} (λ) or the change of θ_{0 opt rigid} (λ, α):
θ_{0 rigid} is set, there is determined the efficiency curve C_{P}(λ) or C_{P}(λ, α) of the wind turbine or water turbine with reference rigid blades at the set θ_{0 rigid}, and
the change θ_{0 opt rigid} (λ) or θ_{0 opt rigid} (λ, α) is deduced therefrom, whose efficiency curve C_{P}(λ, θ_{0 opt rigid} (λ)), or C_{P} (λ, α, θ_{0 opt rigid} (λ, α)) encloses all the curves C_{P}(λ) or C_{P}(λ, α) measured at the set θ_{0 rigid}.

13. The method according to any of claims 1 to 12, wherein the information relating to the choice of the material relates to the distribution of the material(s) within the flexible blade, or includes an information on the distribution of the mass density within the flexible blade, the distribution of the bending modulus within the flexible blade, the insertion of elements external to a blade of fixed geometrical profile.

14. The method according to any of claims 1 to 13, wherein the wind turbine flexible blade is assimilated to a two-dimensional plate, and for which the following equation is satisfied:
$${∇}^{2} ( B ( x , y ) {∇}^{2} w ( x , y , t ) = - q ( x , y , t ) - h ( x , y ) ρ ( x , y ) \frac{{\partial }^{2} w ( x , y , t )}{\partial {t}^{2}}$$
where B is the bending modulus, q the loading due to aerodynamic and centrifugal forces, h the thickness of the plate, ρ the density of the blade and w the transverse deformation of the blade, x and y mark the space, t the time, the left member represents the deformation of the plate, and the first term of the right member represents the loading, and the second term of the right member represents the term of inertia.

15. The method according to any of claims 1 to 14, wherein during step e), the local values of bending modulus B and mass density ρ are determined so that, in operation, the pitch angle does not vary beyond 6°, with respect to a value of the pitch angle of the blade obtained for a position of the blade at rest.

16. A method for manufacturing a flexible blade of a wind turbine or a water turbine, the method comprising steps of:
implementing the method according to any of claims 1 to 15 so as to design a wind turbine or water turbine flexible blade;
manufacturing said flexible blade according to the design of the wind turbine or water turbine flexible blade obtained.

17. A wind turbine or water turbine blade, characterized in that it is flexible according to the chord, and is manufactured according to the method according to claim 16, the flexibility of said blade passively regulating the pitch angle of the wind turbine or water turbine in operation.

18. The wind turbine or water turbine flexible blade according to claim 17, wherein the mass density is inhomogeneous and/or the bending modulus is inhomogeneous.

19. The wind turbine or water turbine flexible blade according to any of claims 17 to 18, further comprising inserted external elements.

20. A wind turbine or water turbine comprising a plurality of flexible blades according to any of claims 17 to 19.

21. A method for designing a predefined wind turbine or water turbine rigid blade, the rigid blade having a known geometrical profile: a known span as well as a thickness and a chord that are known and variable in the spanwise direction, a pitch angle at rest, the rigid blade being hinged around an arm of the wind turbine/water turbine, the rigid blade being able to perform a rotational movement around the arm according to its span, at least one torsion spring connecting the rigid blade with the arm whose stiffness K is chosen for passively regulating the pitch angle of the wind turbine or water turbine in operation, the method comprising the following steps:
a) receiving the known geometrical profile,
b) determining, for said geometrical profile applied to a reference rigid blade, a change of the optimum pitch angle of the rigid blade θ_{0 opt rigid} as a function at least of the specific speed λ equal to the ratio between the speed considered at the end of the blade and the incident fluid speed, for a speed regime of the fluid flowing around the rigid blade,
c) determining the behavior of the hinged rigid blade with torsion spring, the hinged rigid blade moving under the effect of the aerodynamic loading of the fluid circulating around this rigid blade, of the elastic return force of the torsion spring and of the centrifugal force exerted on this rigid blade in rotation,
and determining local ratios relating to the aerodynamic loading, to the elastic return force and to the centrifugal force exerted on this hinged rigid blade,
d) determining the stiffness K of the torsion spring and local values of the mass density ρ of the hinged rigid blade, using the local ratios and the behavior of the rigid blade determined in step c) so that the change of an effective pitch angle θ_{0 eff} of the rigid blade, conferred by the torsion of the spring of the rigid blade, as a function of the specific speed λ, corresponds to the change determined in the previous step b), and
e) restituting an information relating to the choice of the material of the hinged rigid blade, and the stiffness K of the torsion spring.

22. The method according to claim 21, wherein the blade belongs to a first category of wind turbines/water turbines called horizontal rotation axis wind turbines/water turbines and for which the wind direction U is orthogonal to the plane of rotation of the blade.

23. The method according to claim 21, wherein the blade belongs to a second category of wind turbines/water turbines called vertical rotation axis or horizontal rotation axis wind turbines/water turbines, when the wind speed U is not orthogonal to the plane of rotation of the blade, and in this case θ_{0 opt rigid} is a function of α, α being the azimuthal angle (angle of rotation of the blade about the axis) and in step b), with each specific speed λ is associated a distribution of θ_{0 opt rigid} (α).

24. The method according to any of claims 21 to 23, wherein:
in step b), the optimum value λ_{max rigid} is determined, for which the efficiency C_{P} of the wind turbine or water turbine with rigid blades of the same fixed geometrical profile as that of the wind turbine/water turbine with flexible blades is maximum,
and wherein the maximum optimum operating point [_{θ0 opt max rigid}, λ_{max rigid}] or respectively the maximum optimum operating point [θ_{0 opt max rigid} (α), λ_{max rigid}] is deduced, using the change of the optimum pitch angle of the reference rigid blade θ_{0 opt rigid} for the first category of wind turbines/water turbines or respectively θ_{0 opt rigid} (a) for the second category of wind turbines/water turbines,
and in step c), a value of the initial pitch angle θ_{0 eff ini} of the hinged rigid blades is determined so that, in operation, the maximum effective operating point [θ_{0 eff max}, λₘₐₓ] for the first category of wind turbine/water turbine or respectively [θ_{0 max eff}(α), λₘₐₓ] for the second category of wind turbine/water turbine having these rigid blades hinged, is equal to the maximum optimum operating point [θ_{0 opt max rigid}, λ_{max rigid}] or respectively [θ_{0 opt max rigid} (α), λ_{max rigid}] of the wind turbine or water turbine with reference rigid blades.

25. The method according to any of claims 21 to 24, wherein during step c), the local ratios relating to the aerodynamic loading and to the centrifugal force exerted on the hinged rigid blade, are the Cauchy's number C_{y} and the centrifugal number C_{c}, and are determined at each point of the hinged rigid blade, the Cauchy's number C_{y} being the ratio of the moments of the aerodynamic force and elastic force, the product C_{c}*λ² for the first category of wind turbine/water turbine, or respectively C_{c}*λ²*(R/W) for the second category of wind turbine/water turbine, being the ratio of the moments of the centrifugal force and elastic force.

26. The method according to claim 25, wherein the Cauchy's number is equal to C_{Y}=ρ_{fluid}U²W_{f}²R/(2K), the centrifugal number being equal to C_{c}=ρU²hW_{f}³/(RK) with, for each considered point of the hinged rigid blade, K the stiffness of the torsion spring, ρ the mass density of the blade, ρ_{fluid} the mass density of the fluid circulating around the blade, U the speed of the incident fluid, W the length of the chord of the considered blade element, R the radius of the pale, h the thickness of the blade.

27. The method according to any of claims 21 to 26, wherein in step b, to determine the change of θ_{0 opt rigid} (λ) for the first category of wind turbine/water turbine or respectively of θ_{0 opt rigid} (λ, α) for the second category of wind turbine/water turbine:
λ is set, the maximum efficiency C_{P}, or respectively the average maximum efficiency C_{P} is determined over a 360° rotation of α about the axis of rotation, of the wind turbine or water turbine with reference rigid blades, and
θ_{0 opt rigid} is deduced therefrom for the first category of wind turbine/water turbine, or respectively θ_{0 opt rigid} (α) for the second category of wind turbine/water turbine, and
this calculation is repeated for each set λ.

28. The method according to any of claims 21 to 27, wherein in step b, to determine the change of θ_{0 opt rigid} (λ) or the change of θ_{0 opt rigid} (λ, α):
θ_{0 rigid} is set, there is determined the efficiency curve C_{P}(λ) or C_{P}(λ, α) of the wind turbine/water turbine with reference rigid blades at the set θ_{0 rigid}, and
the change θ_{0 opt rigid} (λ) or θ_{0 opt rigid} (λ, α) is deduced therefrom, whose efficiency curve C_{P} (λ, θ_{0 opt rigid} (λ)) or C_{P} (λ, α, θ_{0 opt rigid} (λ, α)) encloses all the curves C_{P}(λ) or C_{P}(Δ, α) measured at the set θ_{0 rigid}.

29. The method according to any of claims 21 to 28, wherein the information relating to the choice of the material relates to the distribution of the material(s) within the flexible blade, or includes an information on the distribution of the mass density within the flexible blade, the distribution of the bending modulus within the flexible blade, the insertion of elements external to a blade with fixed geometrical profile.

30. The method according to any of claims 21 to 29, wherein the wind turbine/water turbine hinged blade with its spring satisfies the following equation:
$$K ( θ ( t ) - {θ}_{0} ) = - {\int \int }_{blade} l ( x , y , t ) q ( x , y , t ) dxdy - \frac{{d}^{2} J θ}{{dt}^{2}}$$
where K is the spring constant of the torsion spring(s), θ the pitch angle of the blade, θ₀ the initial pitch angle of the blade (when no force is applied to the blade at rest), l(x, y, t) is the distance between the point of the blade considered on the integral and the axis of rotation of the torsion spring, q(x, y, t) is the loading due to the aerodynamic and centrifugal forces, J is the moment of inertia of the rigid blade hinged with respect to the axis of rotation of the torsion spring(s), J being defined as follows:
$$J ( t ) = {\int \int }_{blade} h ( x , y ) ρ ( x , y ) {l}^{2} ( x , y , t ) dxdy$$
where h(x, y) is the thickness of the blade, p(x, y) is the mass density of the blade, and l(x, y, t) is the distance between the point of the considered blade of coordinates (x, y) and the axis of rotation of the torsion spring.

31. The method according to any of claims 21 to 30,
wherein during step e), the local values of torsional stiffness K and mass density ρ are determined so that, in operation, the pitch angle does not vary beyond 10°, with respect to a value of the blade pitch angle obtained for a position of the blade at rest.

32. A wind turbine or water turbine comprising:
a plurality of rigid blades each hinged to one or several arm(s) of the wind turbine/water turbine,
at least one torsion spring per arm mechanically connecting the arm and the hinged rigid blade, the stiffness of the torsion spring being chosen for passively regulating the pitch angle of the wind turbine or water turbine in operation,
each blade being hinged to the arm so as to rotate about the arm only in the direction of the span of the blade, under the effect of the torsion spring and of the forces due to the rotation of the blade about the axis of rotation of the wind turbine,
the mass density of the hinged rigid blades and the stiffness of the torsion springs are determined by the method defined according to any one of claims 21 to 31.

33. The wind turbine or water turbine according to claim 32, characterized in that the wind turbine has a vertical axis of rotation, or a horizontal axis of rotation when the wind speed U is not orthogonal to the plane of rotation of the blade.

34. The wind turbine or water turbine according to any of claims 32 to 33, the wind turbine having a vertical axis of rotation, or a horizontal axis of rotation when the wind speed U is not orthogonal to the plane of rotation of the blade, characterized in that one end of the torsion spring is fixed inside the rigid blade, a second end is fixed to the arm, the axis of the turn of the torsion spring being collinear with the span, the span being the height (L) of the hinged rigid blade.

35. The wind turbine or water turbine according to claim 34, characterized in that one end of the turn is bearing on the arm.

36. The wind turbine or water turbine according to any of claims 32 to 35, characterized in that the arm has a means for supporting the blade, located in a housing of the blade, this support means allowing the rotation of the hinged blade, the support means being a pivot connection or a ball joint.

37. The wind turbine or water turbine according to any of claims 32 to 36, characterized in that the flexible blade is a flexible blade of a first category of wind turbines/water turbines called horizontal rotation axis wind turbines/water turbines and for which the direction of wind U is orthogonal to the plane of rotation of the blade.

38. The wind turbine or water turbine according to any of claims 32 to 37, characterized in that each hinged blade is connected to the hinge axis by several arms, and has different torsion springs with different stiffnesses K, K′; a stiffness K, K′, different per arm.
